(19) United States
(12) Patent Application Publication
(10) Pub. No.: US 2023/0133460 A1
(43) Pub. Date: May 4, 2023

(54) OPTICAL SYSTEM, LENS MODULE, AND ELECTRONIC DEVICE

(71) Applicant: JIANGXI JINGCHAO OPTICAL CO., LTD., Nanchang (CN)

(72) Inventors: Jian YANG, Nanchang (CN); Ming LI, Nanchang (CN); Lu HUA, Nanchang (CN)

(21) Appl. No.: 17/551,589

(22) Filed: Dec. 15, 2021

(30) Foreign Application Priority Data
Oct. 29, 2021 (CN) 202111270653.8

(51) Int. Cl. G02B 13/00; G02B 9/64; G02B 15/177

(52) U.S. Cl. CPC G02B 13/0045; G02B 13/009; G02B 9/64; G02B 15/177

(57) ABSTRACT

An optical system, a lens module, and an electronic device are provided. The optical system includes sequentially, from an object side to an image side, first to eighth lenses each with a refractive power. The optical system satisfies the expression: 2<fcj/fdj<3, where fcj represents an effective focal length of the optical system at a long focal length end, and fdj represents an effective focal length of the optical system at a short focal length end.

### CROSS-REFERENCE TO RELATED APPLICATION(S)

This application claims priority to Chinese Patent Application No. 202111270653.8, filed on Oct. 29, 2021, the entire disclosure of which is hereby incorporated by reference.

### TECHNICAL FIELD

This disclosure relates to the technical field of optical imaging, and in particular to an optical system, a lens module, and an electronic device.

### BACKGROUND

In the past ten years, with the rapid development of science and technology, lenses with photographic functions that can be mounted on various electronic devices, such as mobile phones, notebooks, computers, automobiles, drones, and smart home devices, has become more and more widely used. Lenses with zoom function can have more flexible and extensive applications. In order to adapt to the diversity of shooting scenes and user shooting needs, the camera needs to obtain clear imaging at both short and long distances, which requires the zoom lens to have sufficient zooming effect. While the zoom lens satisfies the imaging quality at short and long distances, it is often accompanied by an increase in the number of lenses and a complex lens structure.

It is difficult for a current optical system with zoom function to take into account both high zoom ratio and high image quality. Therefore, how to reasonably configure the number of lenses, materials, thickness, refractive power and other parameters according to the specific environment and user needs, and propose a camera system with high zoom ratio, high image quality, and compact size has become the focus of attention in the current field.

### SUMMARY

In a first aspect, an optical system is provided in the disclosure. The optical system includes sequentially, from an object side to an image side along an optical axis, a first lens with a negative refractive power, a second lens with a negative refractive power, a third lens with a positive refractive power, a fourth lens with a positive refractive power, a fifth lens with a negative refractive power, a sixth lens with a refractive power, a seventh lens with a refractive power, and an eighth lens with a refractive power. The first lens has an object-side surface which is convex near the optical axis and an image-side surface which is concave near the optical axis. The third lens has an object-side surface which is convex near the optical axis and an image-side surface which is concave near the optical axis. The fourth lens has an object-side surface and an image-side surface which are convex near the optical axis. The fifth lens has an image-side surface which is concave near the optical axis. The seventh lens has an object-side surface which is concave near the optical axis and an image-side surface which is convex near the optical axis. The eighth lens has an object-side surface which is convex near the optical axis and an image-side surface which is concave near the optical axis, and the object-side surface and the image-side surface each have at least one inflection point. The first to third lenses are fixed relative to one other and constitute a first lens group. The first lens group is fixed. The fourth to sixth lenses are fixed relative to one another and constitute a second lens group. The seventh lens and the eighth lens are fixed relative to one another and constitute a third lens group. The second lens group and the third lens group are movable along the optical axis. The optical system satisfies the following expression: 2<fcj/fdj<3, where fcj represents an effective focal length of the optical system at a long focal length end, and fdj represents an effective focal length of the optical system at a short focal length end.

In a second aspect, a lens module is provided in this disclosure. The lens module includes a lens barrel, a photosensitive element, and the optical system described in the first aspect. The first to eighth lenses of the optical system are installed within the lens barrel. The photosensitive element is disposed at the image side of the optical system.

In a third aspect, an electronic device is provided in the disclosure. The electronic device includes a housing and the lens module described in the second aspect. The lens module is received in the housing.

### BRIEF DESCRIPTION OF THE DRAWINGS

In order to more clearly describe the technical solutions in implementations of the disclosure or the prior art, the following will briefly introduce the drawings that need to be used in the description of the implementations or the prior art. Obviously, the drawings in the following description are only some implementations of the disclosure. For those of ordinary skill in the art, other drawings can be obtained based on these drawings without creative work.

FIG. 1a is a schematic structural diagram illustrating an optical system at a short focal length end according to a first implementation.

FIG. 1b illustrates a longitudinal spherical aberration curve, an astigmatic field curve, and a distortion curve of FIG. 1a.

FIG. 1c is a schematic structural diagram illustrating an optical system at a long focal length end according to the first implementation.

FIG. 1d illustrates a longitudinal spherical aberration curve, an astigmatic field curve, and a distortion curve of FIG. 1c.

FIG. 2a is a schematic structural diagram illustrating an optical system at a short focal length end according to a second implementation.

FIG. 2b illustrates a longitudinal spherical aberration curve, an astigmatic field curve, and a distortion curve of FIG. 2a.

FIG. 2c is a schematic structural diagram illustrating an optical system at a long focal length end according to the second implementation.

FIG. 2d illustrates a longitudinal spherical aberration curve, an astigmatic field curve, and a distortion curve of FIG. 2c.

FIG. 3a is a schematic structural diagram illustrating an optical system at a short focal length end according to a third implementation.

FIG. 3b illustrates a longitudinal spherical aberration curve, an astigmatic field curve, and a distortion curve of FIG. 3a.

FIG. 3c is a schematic structural diagram illustrating an optical system at a long focal length end according to the third implementation.

FIG. 3d illustrates a longitudinal spherical aberration curve, an astigmatic field curve, and a distortion curve of FIG. 3c.

FIG. 4a is a schematic structural diagram illustrating an optical system at a short focal length end according to a fourth implementation.

FIG. 4b illustrates a longitudinal spherical aberration curve, an astigmatic field curve, and a distortion curve of FIG. 4a.

FIG. 4c is a schematic structural diagram illustrating an optical system at a long focal length end according to the fourth implementation.

FIG. 4d illustrates a longitudinal spherical aberration curve, an astigmatic field curve, and a distortion curve of FIG. 4c.

FIG. 5a is a schematic structural diagram illustrating an optical system at a short focal length end according to a fifth implementation.

FIG. 5b illustrates a longitudinal spherical aberration curve, an astigmatic field curve, and a distortion curve of FIG. 5a.

FIG. 5c is a schematic structural diagram illustrating an optical system at a long focal length end according to the fifth implementation.

FIG. 5d illustrates a longitudinal spherical aberration curve, an astigmatic field curve, and a distortion curve of FIG. 5c.

FIG. 6a is a schematic structural diagram illustrating an optical system at a short focal length end according to a sixth implementation.

FIG. 6b illustrates a longitudinal spherical aberration curve, an astigmatic field curve, and a distortion curve of FIG. 6a.

FIG. 6c is a schematic structural diagram illustrating an optical system at a long focal length end according to the sixth implementation.

FIG. 6d illustrates a longitudinal spherical aberration curve, an astigmatic field curve, and a distortion curve of FIG. 6c.

FIG. 7a is a schematic structural diagram illustrating an optical system at a short focal length end according to a seventh implementation.

FIG. 7b illustrates a longitudinal spherical aberration curve, an astigmatic field curve, and a distortion curve of FIG. 7a.

FIG. 7c is a schematic structural diagram illustrating an optical system at a long focal length end according to the seventh implementation.

FIG. 7d illustrates a longitudinal spherical aberration curve, an astigmatic field curve, and a distortion curve of FIG. 7c.

### DETAILED DESCRIPTION

The following describes the technical solutions in implementations of the disclosure clearly and completely in conjunction with the accompanying drawings in the implementations of the disclosure. Obviously, the described implementations are only a part rather than all of the implementations. Based on the implementations of the disclosure, all other implementations obtained by those of ordinary skill in the art without creative work shall fall within the protection scope of the disclosure.

An optical system is provided in the disclosure. The optical system includes sequentially, from an object side to an image side along an optical axis, a first lens with a negative refractive power, a second lens with a negative refractive power, a third lens with a positive refractive power, a fourth lens with a positive refractive power, a fifth lens with a negative refractive power, a sixth lens with a refractive power, a seventh lens with a refractive power, and an eighth lens with a refractive power. The first lens has an object-side surface which is convex near the optical axis and an image-side surface which is concave near the optical axis. The third lens has an object-side surface which is convex near the optical axis and an image-side surface which is concave near the optical axis. The fourth lens has an object-side surface and an image-side surface which are convex near the optical axis. The fifth lens has an image-side surface which is concave near the optical axis. The seventh lens has an object-side surface which is concave near the optical axis and an image-side surface which is convex near the optical axis. The eighth lens has an object-side surface which is convex near the optical axis and an image-side surface which is concave near the optical axis, and the object-side surface and the image-side surface each have at least one inflection point. The first to third lenses are fixed relative to one another and constitute a first lens group. The first lens group is fixed. The fourth to sixth lenses are fixed relative to one another and constitute a second lens group. The seventh lens and the eighth lens are fixed relative to one another and constitute a third lens group. The second lens group and the third lens group are movable along the optical axis. The optical system satisfies the following expression: 2<fcj/fdj<3, where fcj represents an effective focal length of the optical system at a long focal length end, and fdj represents an effective focal length of the optical system at a short focal length end.

The first lens has the negative refractive power in coordination with a meniscus surface that protrudes toward the object side at the optical axis, which is conducive to large-angle light entering the optical system and enlarge the range of field of view of the optical system, and is thus beneficial for the optical system to obtain a relatively large field of view at the short focus state. The second lens with the negative refractive power cooperates with the first lens to further increase the range of field of view of the optical system. The third lens has the positive refractive power, which is beneficial to balance the aberrations generated by the first two lenses in the first lens group, and at the same time provides the positive refractive power for the optical system, which is beneficial to rationally deflect the light and make the light propagate to next lens group at a smaller deflection angle. The object-side surface of the third lens is convex near the optical axis, and the image-side surface of the third lens is concave near the optical axis, which is beneficial to correct field curvature, reduce assembly sensitivity, and improve resolution of the optical system. The fourth lens is the first lens in the second lens group and has the positive refractive power, which is conducive to the divergence of light in the second lens group, helps to obtain a larger focal length in the long focus state, and improves the zoom ratio. At the same time, the fourth lens cooperates with rear lenses to correct aberrations well. The object-side surface and the image-side surface of the fourth lens are both convex near the optical axis, and the double-convex surface profile at the optical axis facilitates the fourth lens to have the strong positive refractive power and shorten a total length of the optical system. The fifth lens has the negative refractive power, which is conducive to the divergence of light and reduce the angle of light exiting from the edge of the fourth lens. The image-side surface of the fifth lens is concave near the optical axis, which can maintain a proper thickness and is beneficial to the processing and manufacturing of the fifth lens. The seventh lens with the refractive power has the object side which is concave near the optical axis and the image side which is convex near the optical axis, which helps to obtain a reasonable incident angle when the light passes through the eighth lens and is incident into the imaging surface, so as to ensure that the edge part can also obtain a higher relative brightness, thereby avoiding the vignetting of the edge during imaging, and ensuring good imaging quality. The eighth lens with the refractive power has the object-side surface which is convex near the optical axis and the image-side surface which is concave near the optical axis, which is beneficial to balance aberration generated by the front lens group, so that the optical system achieves aberration balance and an improved imaging quality. In addition, the image-side surface is concave near the optical axis, which is beneficial to maintain a sufficient back focal length (that is, a minimum distance from the image-side surface of the eighth lens to the imaging surface of the optical system along the optical system), cooperating with a high-resolution chip to achieve high-definition imaging. The object-side surface and the image-side surface of the eighth lens each have at least one inflection point, which is beneficial to correct the distortion generated by the optical system, reasonably control the overall aberration of the optical system, and achieve good imaging quality. In addition, by making the optical system meet the above expression, the ratio of the focal length of the optical system in the long focus state to the focal length in the short focus state is greater than 2, which can ensure a high zoom ratio of the optical system and realize a large zoom range of an electronic device equipped with the zoom lens, enhancing product competitiveness.

In an implementation, the optical system satisfies the following expression: 10<TTL/FFLdj<20, where TTL represents a distance from the object-side surface of the first lens to an imaging surface of the optical system on the optical axis, and FFLdj represents a back focal length of the optical system at the short focal length end. A reasonable ratio of the total length of the optical system to the back focal length is beneficial to shorten the total length of the optical system. By making the optical system meet the above expression, it is possible to ensure that there is a sufficient safety distance between the optical system and the chip, thus reducing the design difficulty of the lens barrel. In addition, it is also beneficial for the light in edge field of view to enter the photosensitive element, so that a reasonable chief ray angle can be achieved, thereby avoiding vignetting and improving imaging quality.

In an implementation, the optical system satisfies the following expression: −1.5<fcj/f78<−0.4; wherein fcj represents the effective focal length of the optical system at the long focal length end, and f78 represents a combined effective focal length of the third lens group. By making the optical system meet the above expression, the contribution to the negative refractive power of the third lens group can be reasonably distributed, which is beneficial to a relatively large effective focal length when the optical system is at the long focal length end, thus obtaining a large zoom ratio.

In an implementation, the optical system satisfies the following expression: −2.5<f3/f123<−1.5, where f3 represents an effective focal length of the third lens, and f123 represents a combined effective focal length of the first lens group. By making the optical system meet the above expression, while the first lens group provides sufficient negative refractive power for the optical system, the third lens has sufficient positive refractive power to balance the negative spherical aberration generated by the first lens and the second lens. In addition, it is beneficial for the edge light to enter the fourth lens smoothly, reducing the tolerance sensitivity of the fourth lens, and reducing the manufacturing difficulty.

In an implementation, the optical system satisfies the following expression: 0.9<f456/f4<1.5, where f456 represents a combined effective focal length of the second lens group, and f4 represents an effective focal length of the fourth lens. By making the optical system meet the above expression, the fourth lens contributes a strong positive refractive power to the second lens group, so that the second lens group has enough positive refractive power to converge the light emitting from the first lens group, and at the same time balance the negative refractive power of the fifth lens, which is beneficial to reduce a distance from a maximum effective aperture of the object-side surface of the fifth lens to a maximum effective aperture of the image-side surface of the fifth lens on the optical axis, thereby shortening the total length of the second lens group and achieving miniaturization of the optical system.

In an implementation, the optical system satisfies the following expression: 2<R32/R41<4.5, where R32 represents a radius of curvature of the image-side surface of the third lens at the optical axis, and R41 represents a radius of curvature of the object-side surface of the fourth lens at the optical axis. By making the optical system meet the above expression, the surface profiles of the last surface of the first lens group and the first surface of the second lens group can be restrained reasonably, which is conducive to the transition of the light in edge field of view with a relatively reasonable deflection angle, and at the same time is beneficial to correct the aberration of the optical system, improve the imaging quality, and ensure the machinability of the third lens and the fourth lens. When R32/R41 is greater than the upper limit in the above expression, the surface profile of the image-side surface of third lens is too smooth, and an angle of emergence of the edge light is too large after exiting from the image-side surface of the third lens, so that it is likely to produce stray light after the exit light is reflected by the non-optical effective area of the fourth lens, and it is unfavorable for aberration correction. When R32/R41 is less than the lower limit in the above expression, the image-side surface of the third lens is too curved, which may increase the difficulty in lens forming and processing.

In an implementation, the optical system satisfies the following expression: 2<Rg2cj/Rg2dj<2.5, where Rg2dj represents a ratio of a total length of the second lens group to a distance from the image-side surface of the third lens to the object-side surface of the seventh lens on the optical axis when the optical system is at the short focal length end, and Rg2cj represents a ratio of the total length of the second lens group to the distance from the image-side surface of the third lens to the object-side surface of the seventh lens on the optical axis when the optical system is at the long focal length end. By making the optical system meet the above expression, it can be ensured that the ratio of the total length of the second lens group to the distance from the image-side surface of the third lens to the object-side surface of the seventh lens on the optical axis in the long-focus and short-focus states is within a reasonable range, which on the one hand is beneficial to shorten the total length of the optical system, and on the other hand is conductive to a smooth zoom process, so that a gap between two adjacent lens groups is appropriate, and there will be no collision when switching the focus state, thus ensuring the stability of the zoom system. When Rg2cj/Rg2dj is less than the lower limit in the above expression, when the optical system is in the long focal length end, the distance from the image-side surface of the third lens to the object-side surface of the seventh lens on the optical axis is too large, which is unfavorable for shortening the total length of the optical system. When Rg2cj/Rg2dj is greater than the upper limit in the above expression, the change in the focal length of the optical system is too small, thus narrowing the zoom range of the optical system.

In an implementation, the optical system satisfies the following expression: SDmax/ImgH<1.3, where SDmax represents a maximum value of maximum effective semi-diameters of the first to eighth lenses, and ImgH represents half of an image height corresponding to a maximum angle of view of the optical system. By making the optical system meet the above expression, the maximum value of maximum effective semi-diameters of the first to eighth lenses can be constrained in a reasonable range, which is beneficial to reduce the volume of the optical system, so as to save space for an electronic device carrying the optical system. In addition, the large image plane of the optical system can cooperate with a high-resolution chip to achieve high-resolution imaging. When SDmax/ImgH is greater than the upper limit in the above expression, the maximum value of maximum effective semi-diameters is too large, which is unfavorable to save space and cost, and at the same time will lead to a larger ratio of an outer diameter to a center thickness, reducing stability of the optical system.

In an implementation, the optical system satisfies the following expression: N3/N4>1.2, where N3 represents a refractive index of the third lens, and N4 represents a refractive index of the fourth lens. By making the optical system meet the above expression, the third lens adopts a high refractive index and the fourth lens adopts a low refractive index, which is conducive to the chromatic aberration correction of the optical system and achieves a reasonable balance of chromatic aberration throughout the optical system.

A lens module is further provided in this disclosure. The lens module includes a lens barrel, a photosensitive element, and the optical system of any of implementations described above. The first to eighth lenses of the optical system are installed within the lens barrel. The photosensitive element is disposed at the image side of the optical system. By adding the optical system provided in the disclosure to the lens module, surface profiles and refractive powers of respective lenses in the optical system can be reasonably designed, and the lens module can have characteristics of high zoom ratio, high image quality, and compact size.

An electronic device is further provided in the disclosure. The electronic device includes a housing and the lens module provided in implementations of the disclosure. The lens module is received in the housing. By adding the lens module provided in the disclosure to the electronic device, the electronic device can have a high zoom ratio and high image quality as well as a compact size.

First Implementation

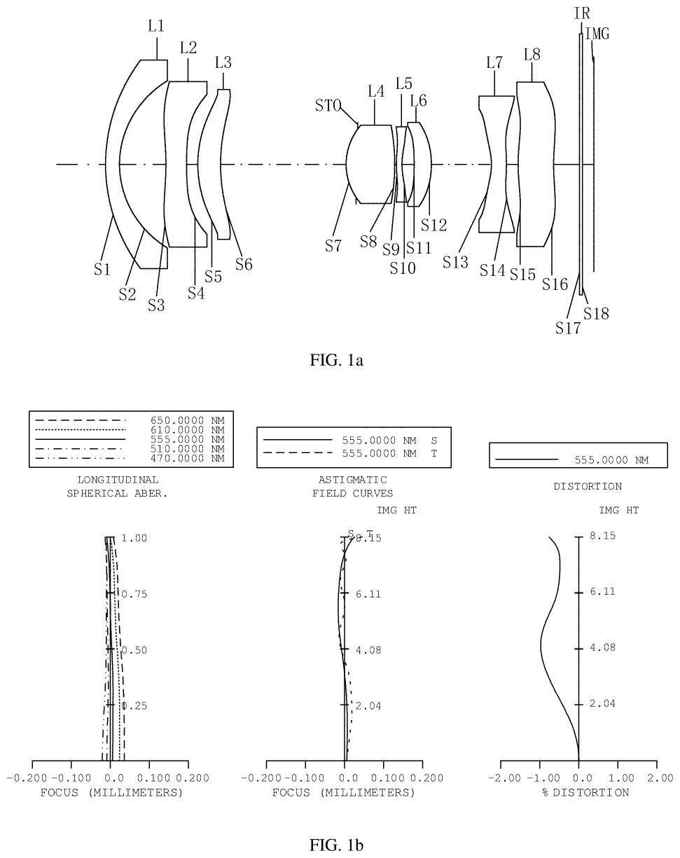

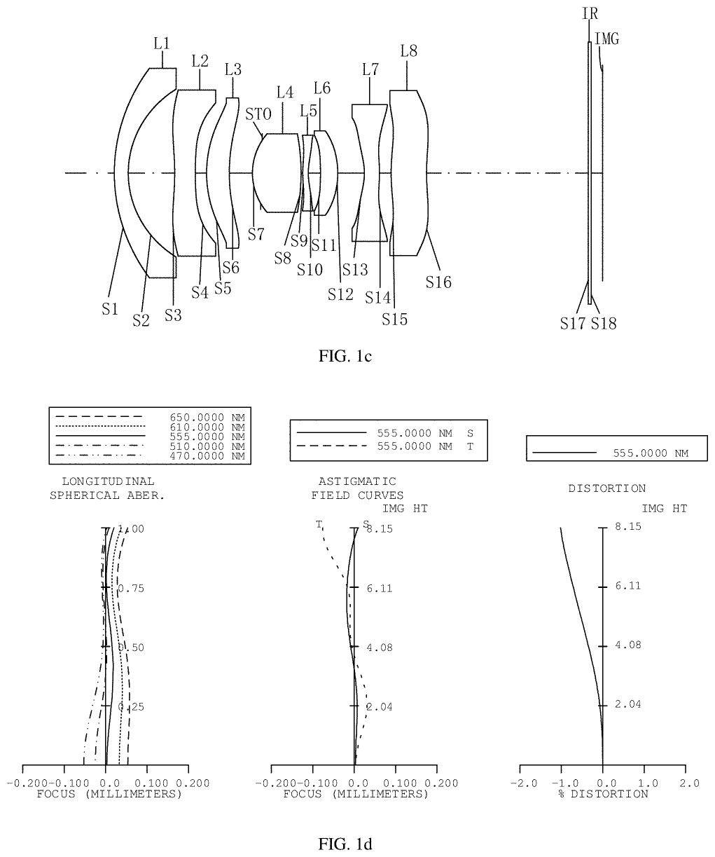

Referring to FIG. 1a and FIG. 1c, an optical system of this implementation includes sequentially from an object side to an image side along an optical axis:

a first lens L1 with a negative refractive power, where the first lens L1 has an object-side surface S1 which is convex both near the optical axis and near a periphery and an image-side surface S2 which is concave both near the optical axis and near a periphery;

a second lens L2 with a negative refractive power, where the second lens L2 has an object-side surface S3 which is concave both near the optical axis and near a periphery and an image-side surface S4 which is concave both near the optical axis and near a periphery;

a third lens L3 with a positive refractive power, where the third lens L3 has an object-side surface S5 which is convex near the optical axis and concave near a periphery and an image-side surface S6 which is concave near the optical axis and convex near a periphery;

a fourth lens L4 with a positive refractive power, where the fourth lens L4 has an object-side surface S7 which is convex both near the optical axis and near a periphery and an image-side surface S8 which is convex both near the optical axis and near a periphery;

a fifth lens L5 with a negative refractive power, where the fifth lens L5 has an object-side surface S9 which is convex both near the optical axis and near a periphery and an image-side surface S10 which is concave both near the optical axis and near a periphery;

a sixth lens L6 with a positive refractive power, where the sixth lens L6 has an object-side surface S11 which is concave both near the optical axis and near a periphery and an image-side surface S12 which is convex both near the optical axis and near a periphery;

a seventh lens L7 with a negative refractive power, where the seventh lens L7 has an object-side surface S13 which is concave both near the optical axis and near a periphery and an image-side surface S14 which is convex both near the optical axis and near a periphery; and

eighth lens L8 with a positive refractive power, where the eighth lens L8 has an object-side surface S15 which is convex near the optical axis and concave near a periphery and an image-side surface S16 which is concave near the optical axis and convex near a periphery.

The first lens L1 to the eighth lens L8 may be made of plastic, glass, or a mixed material of glass and plastic.

In addition, the optical system further includes a stop STO. In this implementation, the stop STO is disposed at the object-side surface S7 of the fourth lens L7. In other implementations, the stop STO may also be disposed at the object side of the optical system, between any two lenses, or at other lens surface. The optical system further includes an infrared cut-off filter IR and an imaging surface IMG. The infrared cut-off filter IR is disposed between the image-side surface S16 of the eighth lens L8 and the imaging surface IMG. The infrared cut-off filter IR has an object-side surface S17 and an image-side surface S18. The infrared cut-off filter IR is used to filter out the infrared light, so that light incident into the imaging surface IMG is visible light which has a wavelength of 380 nm-780 nm. The infrared cut-off filter IR is made of glass and the glass may be coated, such as cover glass with filter function, or may be COB (chips on board) formed by directly packaging a bare chip with a filter. The effective pixel area of the electronic photosensitive element is located on the imaging surface IMG.

Table 1a illustrates characteristics of the optical system of this implementation. A reference wavelength of the focal length is 555 nm. A reference wavelength of material refractive index and the Abbe number is 587.56 nm. Y radius is the radius of curvature of the object-side surface or the image-side surface with corresponding surface number at the optical axis. The first value in the “thickness” parameter column is a thickness of the lens on the optical axis, and the second value is a distance from the image-side surface of the lens to the immediately rear surface on the optical axis. D1 represents a distance from the image-side surface S6 of the third lens L3 to the object-side surface S7 of the fourth lens L4 on the optical axis. D2 represents a distance from the image-side surface S12 of the sixth lens L6 to the object-side surface S13 of the seventh lens L7 on the optical axis. D3 represents a distance from the image-side surface S16 of the eighth lens L8 to the imaging surface IMG on the optical axis. The units of Y radius, thickness, and effective focal length are all millimeters (mm).

TABLE 1a
First implementation
EFL = 8.917 mm/18.326 mm; FNO = 2.831/5.003;
FOV = 85.39 deg/48.437 deg; TTL = 35.02 mm

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | 1.00E+18 | 9.30E+15 | | | | |
| surface | surface | | | | | | | |
| S1 | First | spheric | 13.76952 | 1.0000 | glass | 1.816 | 46.57 | −22.420 |
| S2 | lens L1 | spheric | 7.60000 | 3.3292 | | | | |
| S3 | Second | aspheric | −19.99989 | 1.4799 | plastic | 1.544 | 56.11 | −23.829 |
| S4 | lens L2 | aspheric | 37.82279 | 0.8101 | | | | |
| S5 | Third | aspheric | 9.42591 | 1.6281 | glass | 1.847 | 23.83 | 29.481 |
| S6 | lens L3 | aspheric | 13.94591 | D1 | | | | |
| STO | Stop | spheric | 4.74504 | 0.0000 | | | | |
| S7 | Fourth | spheric | 4.74504 | 3.4866 | glass | 1.438 | 94.58 | 8.887 |
| S8 | lens L4 | spheric | −16.77341 | 0.1216 | | | | |
| S9 | Fifth | aspheric | 8.78090 | 0.4000 | plastic | 1.635 | 23.90 | −20.257 |
| S10 | lens L5 | aspheric | 5.12597 | 0.8729 | | | | |
| S11 | Sixth | aspheric | −24.03743 | 1.2365 | plastic | 1.544 | 56.11 | 16.877 |
| S12 | lens L6 | aspheric | −6.76476 | D2 | | | | |
| S13 | Seventh | aspheric | −4.48963 | 1.0793 | plastic | 1.544 | 56.11 | −14.326 |
| S14 | lens L7 | aspheric | −11.48469 | 0.8359 | | | | |
| S15 | Eighth | aspheric | 13.37035 | 2.5442 | plastic | 1.635 | 23.90 | 90.238 |
| S16 | lens L8 | aspheric | 16.15145 | D3 | | | | |
| S17 | Infrared | spheric | 9.30E+18 | 0.2100 | glass | 1.517 | 64.17 | |
| S18 | cut-off | spheric | 9.30E+18 | 0.8104 | | | | |
| | filter IR | | | | | | | |
| IMG | Imaging | spheric | Infinity | 0.0000 | | | | |
| | surface | | | | | | | |

In this table, EFL represents an effective focal length of the optical system, which includes an effective focal length fdj when the optical system is at the short focal length end and an effective focal length fcj when the optical system is at the long focal length end. FNO represents an F-number of the optical system. FOV represents a maximum angle of view of the optical system in deg. TTL represents a distance from the object-side surface of the first lens to the imaging surface of the optical system on the optical axis. When the optical system is at the short focal length end, fdj=8.917 mm, FNO=2.831, FOV=85.39 deg, D1=9.01 mm, D2=4.31 mm, D3=1.86 mm. When the optical system is at the long focal length end, fcj=18.326 mm, FNO=5.003, FOV=48.437 deg, D1=1.66 mm, D2=1.91 mm, D3=11.60 mm.

In this implementation, the object-side surfaces and the image-side surfaces of the second lens L2, the third lens L3, and the fifth lens L5 to the eighth lens L8 are all aspheric surfaces. The surface profile of the aspheric surface can be limited by (but is not limited to) the following expression:

$$x = \frac{{ch}^{2}}{1 + \sqrt{1 - ( k + 1 ) {c}^{2} {h}^{2}}} + \sum {Aih}^{i}$$

In this expression, x represents a distance from a corresponding point on the aspheric surface to a plane tangent to a vertex of the surface, h represents a distance from the corresponding point on the aspheric surface to the optical axis, c represents a curvature of the vertex of the aspheric surface, k represents a conic coefficient, and Ai represents a coefficient corresponding to the i-th high-order term in the aspheric surface profile expression. Table 1b shows high-order term coefficients A4, A6, A8, A10, A12, A14, A16, A18, and A20 which can be used for the aspheric surfaces S3, S4, S5, S6, S9, S10, S11, S12, S13, S14, S15, and S16 in this implementation.

TABLE 1b
First implementation

| Surface number | K | A4 | A6 | A8 | A10 |
|---|---|---|---|---|---|
| S3 | 0.000E+00 | 1.335E−03 | −1.383E−05 | −4.337E−08 | 9.742E−10 |
| S4 | 0.000E+00 | 1.573E−03 | 4.036E−06 | −2.024E−07 | −1.996E−08 |
| S5 | 0.000E+00 | 2.358E−05 | 1.976E−06 | −4.541E−07 | 0.000E+00 |
| S6 | 0.000E+00 | −9.164E−05 | −6.522E−06 | −2.236E−07 | 0.000E+00 |
| S9 | 0.000E+00 | −1.353E−02 | 7.087E−04 | 2.217E−05 | −2.098E−06 |
| S10 | 0.000E+00 | −1.469E−02 | 7.860E−04 | 9.185E−07 | 3.921E−07 |
| S11 | 0.000E+00 | −2.458E−03 | −2.301E−04 | −3.732E−05 | 8.575E−06 |
| S12 | 0.000E+00 | −3.515E−04 | −5.225E−05 | −8.578E−06 | 1.837E−06 |
| S13 | 0.000E+00 | 1.546E−02 | −1.493E−03 | 1.353E−04 | −1.023E−05 |
| S14 | 0.000E+00 | 1.061E−02 | −7.485E−04 | 2.950E−05 | −4.441E−07 |
| S15 | 0.000E+00 | −3.119E−03 | 1.644E−04 | −1.270E−05 | 7.997E−07 |
| S16 | 0.000E+00 | −2.851E−03 | 1.429E−04 | −9.025E−06 | 4.270E−07 |
| Surface number | A12 | A14 | A16 | A18 | A20 |
| S3 | 3.244E−11 | −5.321E−13 | 0.000E+00 | 0.000E+00 | 0.000E+00 |
| S4 | 4.507E−10 | 0.000E+00 | 0.000E+00 | 0.000E+00 | 0.000E+00 |
| S5 | 0.000E+00 | 0.000E+00 | 0.000E+00 | 0.000E+00 | 0.000E+00 |
| S6 | 0.000E+00 | 0.000E+00 | 0.000E+00 | 0.000E+00 | 0.000E+00 |
| S9 | 0.000E+00 | 0.000E+00 | 0.000E+00 | 0.000E+00 | 0.000E+00 |
| S10 | 0.000E+00 | 0.000E+00 | 0.000E+00 | 0.000E+00 | 0.000E+00 |
| S11 | −4.198E−07 | 0.000E+00 | 0.000E+00 | 0.000E+00 | 0.000E+00 |
| S12 | −9.615E−08 | 0.000E+00 | 0.000E+00 | 0.000E+00 | 0.000E+00 |
| S13 | 5.887E−07 | −2.126E−08 | 3.550E−10 | 0.000E+00 | 0.000E+00 |
| S14 | −1.579E−08 | 8.729E−10 | −1.244E−11 | 0.000E+00 | 0.000E+00 |
| S15 | −3.897E−08 | 1.220E−09 | −1.585E−11 | 0.000E+00 | 0.000E+00 |
| S16 | −1.319E−08 | 2.286E−10 | −1.625E−12 | 0.000E+00 | 0.000E+00 |

FIG. 1b (short focal length) and FIG. 1d (long focal length) illustrate in (a) respectively the longitudinal spherical aberration curves of the optical system for different focal lengths in this implementation under wavelengths of 650.0000 nm, 610.0000 nm, 555.0000 nm, 510.0000 nm, 470.0000 nm. The abscissa along the X axis represents focus deviation, and the ordinate along the Y axis represents the normalized field of view. The longitudinal spherical aberration curve represents the focus deviation of lights of different wavelengths after passing through the lenses in the optical system. As can be seen from (a) in FIG. 1b (short focal length) and FIG. 1d (long focal length), the optical system in this implementation has good spherical aberration, which indicates that the optical system has good image quality.

FIG. 1b (short focal length) and FIG. 1d (long focal length) illustrate in (b) respectively the astigmatic field curves of the optical system for different focal lengths in this implementation under a wavelength of 555.0000 nm. The abscissa along the X axis represents the focus deviation, and the ordinate along the Y axis represents the image height in mm. The astigmatic field curve represents tangential field curvature T and sagittal field curvature S. As can be seen from (b) in FIG. 1b (short focal length) and FIG. 1d (long focal length), the astigmatism of the optical system is well compensated.

FIG. 1b (short focal length) and FIG. 1d (long focal length) illustrate in (c) respectively the distortion curves of the optical system for different focal lengths in this implementation under a wavelength of 555.0000 nm. The abscissa along the X axis represents the focus deviation, and the ordinate along the Y axis represents the image height. The distortion curve represents distortion values corresponding to different angles of view. As can be seen from (c) in FIG. 1b (short focal length) and FIG. 1d (long focal length), the distortion of the optical system is well corrected under the wavelength of 555.0000 nm.

It can be seen from (a), (b), and (c) in FIG. 1b (short focal length) and FIG. 1d (long focal length) that the optical system of this implementation has small aberration, good imaging performance, and good image quality.

Second Implementation

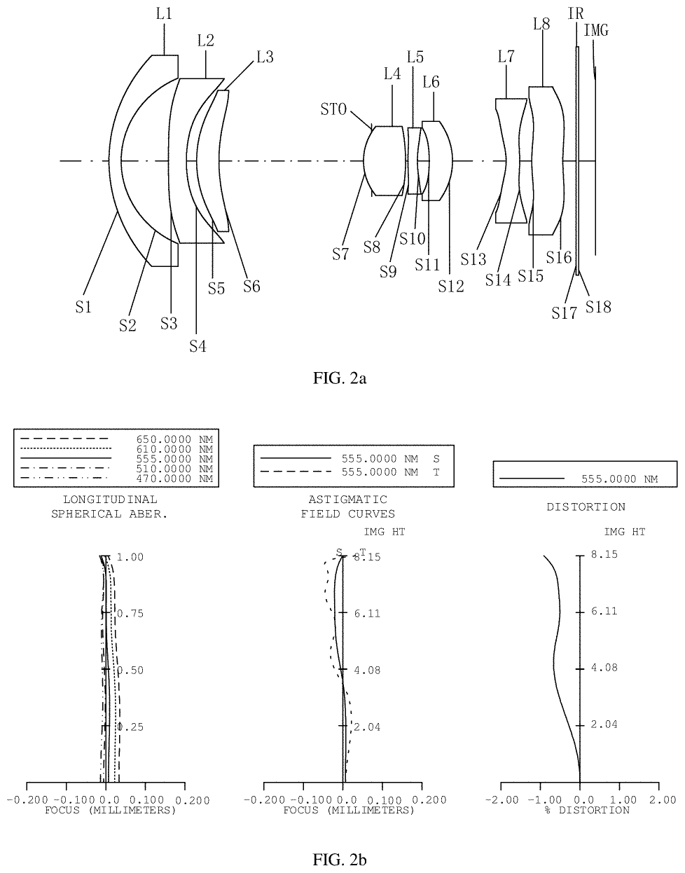

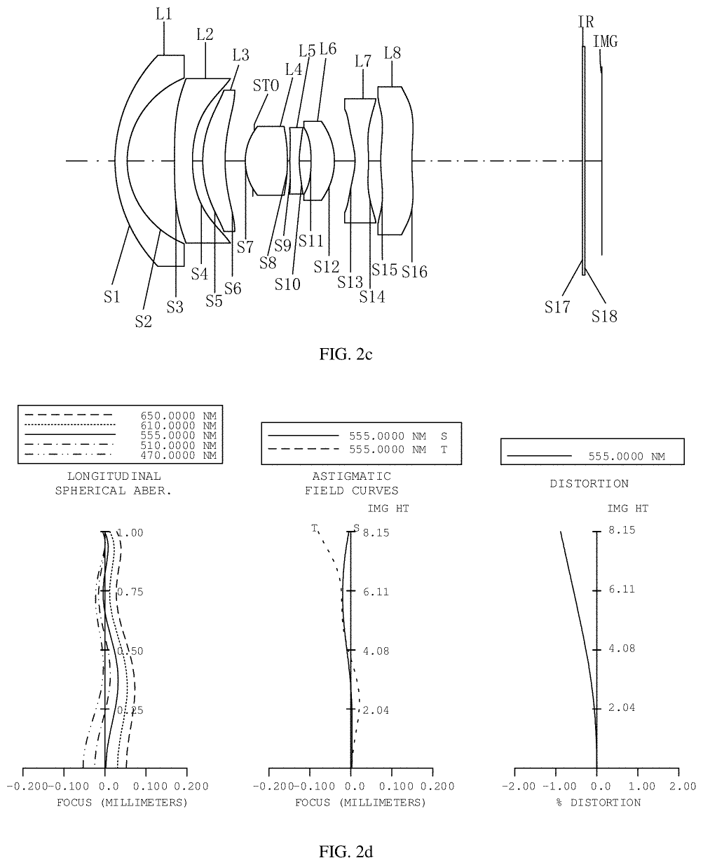

Referring to FIG. 2a and FIG. 2c, an optical system of this implementation includes sequentially from an object side to an image side along an optical axis:

a first lens L1 with a negative refractive power, where the first lens L1 has an object-side surface S1 which is convex both near the optical axis and near a periphery and an image-side surface S2 which is concave both near the optical axis and near a periphery;

a second lens L2 with a negative refractive power, where the second lens L2 has an object-side surface S3 which is convex near the optical axis and concave near a periphery and an image-side surface S4 which is concave both near the optical axis and near a periphery;

a third lens L3 with a positive refractive power, where the third lens L3 has an object-side surface S5 which is convex near the optical axis and concave near a periphery and an image-side surface S6 which is concave near the optical axis and convex near a periphery;

a fourth lens L4 with a positive refractive power, where the fourth lens L4 has an object-side surface S7 which is convex both near the optical axis and near a periphery and an image-side surface S8 which is convex both near the optical axis and near a periphery;

a fifth lens L5 with a negative refractive power, where the fifth lens L5 has an object-side surface S9 which is convex near the optical axis and concave near a periphery and an image-side surface S10 which is concave both near the optical axis and near a periphery;

a sixth lens L6 with a positive refractive power, where the sixth lens L6 has an object-side surface S11 which is concave both near the optical axis and near a periphery and an image-side surface S12 which is convex both near the optical axis and near a periphery;

a seventh lens L7 with a negative refractive power, where the seventh lens L7 has an object-side surface S13 which is concave both near the optical axis and near a periphery and an image-side surface S14 which is convex both near the optical axis and near a periphery; and

an eighth lens L8 with a positive refractive power, where the eighth lens L8 has an object-side surface S15 which is convex near the optical axis and concave near a periphery and an image-side surface S16 which is concave near the optical axis and convex near a periphery.

Other structures in this implementation are the same as that of the first implementation, and reference may be made to the above.

Table 2a shows characteristics of the optical system of this implementation, where the focal length, material refractive index, and Abbe number are all obtained with visible light with a reference wavelength of 587 nm. The units of Y radius, thickness, and effective focal length are all millimeters (mm). Other parameters have the same meaning as the parameters in the first implementation.

TABLE 2a
Second implementation
EFL = 8.916 mm/22.026 mm; FNO = 2.831/5.003;
FOV = 85.478 deg/40.977 deg; TTL = 40 mm

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | 1.00E+18 | 9.30E+15 | | | | |
| surface | surface | | | | | | | |
| S1 | First | spheric | 13.6597 | 1.0000 | glass | 1.816 | 46.568 | −24.569 |
| S2 | lens L1 | spheric | 7.8571 | 3.8815 | | | | |
| S3 | Second | aspheric | 98.5546 | 1.4799 | plastic | 1.544 | 56.114 | −24.854 |
| S4 | lens L2 | aspheric | 11.8284 | 0.8416 | | | | |
| S5 | Third | aspheric | 10.1791 | 1.8368 | glass | 1.847 | 23.825 | 29.870 |
| S6 | lens L3 | aspheric | 15.6266 | D1 | | | | |
| STO | Stop | | 4.9440 | | | | | |
| S7 | Fourth | spheric | 4.9440 | 3.4593 | glass | 1.438 | 94.575 | 9.081 |
| S8 | lens L4 | spheric | −15.9761 | 0.2000 | | | | |
| S9 | Fifth | aspheric | 18.2769 | 0.7724 | plastic | 1.635 | 23.902 | −21.647 |
| S10 | lens L5 | aspheric | 7.7161 | 0.9724 | | | | |
| S11 | Sixth | aspheric | −13.3131 | 1.9151 | plastic | 1.544 | 56.114 | 18.872 |
| S12 | lens L6 | aspheric | −6.0909 | D2 | | | | |
| S13 | Seventh | aspheric | −4.7941 | 1.1079 | plastic | 1.544 | 56.114 | −14.172 |
| S14 | lens L7 | aspheric | −13.7054 | 0.9982 | | | | |
| S15 | Eighth | aspheric | 13.8499 | 2.5562 | plastic | 1.635 | 23.902 | 79.059 |
| S16 | lens L8 | aspheric | 17.7564 | D3 | | | | |
| S17 | Infrared | spheric | 9.30E+18 | 0.2100 | plastic | 1.517 | 64.17 | |
| S18 | cut-off | spheric | 9.30E+18 | 1.4020 | | | | |
| | filter IR | | | | | | | |
| IMG | Imaging | spheric | Infinity | 0.0000 | | | | |
| | surface | | | | | | | |

When the optical system is at the short focal length end, fdj=8.916 mm, FNO=2.831, FOV=85.478 deg, D1=11.878 mm, D2=4.410 mm, D3=1.080 mm. When the optical system is at the long focal length end, fcj=22.026 mm, FNO=5.003, FOV=40.977 deg, D1=1.66 mm, D2=1.698 mm, D3=14.008 mm.

Table 2b shows high-order term coefficients which can be used for the aspheric surfaces in this implementation, where the respective aspheric surface profiles can be limited by the expression given in the first implementation.

TABLE 2b
Second implementation

| Surface number | K | A4 | A6 | A8 | A10 |
|---|---|---|---|---|---|
| S3 | 0.000E+00 | 2.770E−04 | 6.130E−06 | −2.394E−07 | 3.421E−09 |
| S4 | 0.000E+00 | 4.759E−04 | 8.693E−06 | −2.952E−07 | 1.315E−09 |
| S5 | 0.000E+00 | 1.459E−04 | −6.744E−06 | −7.854E−08 | 0.000E+00 |
| S6 | 0.000E+00 | 4.762E−05 | −1.113E−05 | 3.037E−08 | 0.000E+00 |
| S9 | 0.000E+00 | −5.399E−03 | 2.244E−04 | 2.829E−07 | −1.940E−08 |
| S10 | 0.000E+00 | −6.266E−03 | 3.110E−04 | −4.320E−06 | 4.834E−07 |
| S11 | 0.000E+00 | −3.623E−03 | −2.100E−05 | −1.367E−05 | 3.166E−06 |
| S12 | 0.000E+00 | −4.623E−04 | −1.090E−06 | 3.663E−06 | −9.391E−08 |
| S13 | 0.000E+00 | 1.220E−02 | −9.701E−04 | 7.595E−05 | −5.171E−06 |
| S14 | 0.000E+00 | 7.455E−03 | −3.537E−04 | 1.297E−06 | 7.435E−07 |
| S15 | 0.000E+00 | −3.501E−03 | 2.280E−04 | −1.818E−05 | 1.132E−06 |
| S16 | 0.000E+00 | −2.656E−03 | 1.240E−04 | −7.128E−06 | 3.082E−07 |
| Surface number | A12 | A14 | A16 | A18 | A20 |
| S3 | −2.498E−11 | 3.991E−14 | 0.000E+00 | 0.000E+00 | 0.000E+00 |
| S4 | −7.705E−12 | 0.000E+00 | 0.000E+00 | 0.000E+00 | 0.000E+00 |
| S5 | 0.000E+00 | 0.000E+00 | 0.000E+00 | 0.000E+00 | 0.000E+00 |
| S6 | 0.000E+00 | 0.000E+00 | 0.000E+00 | 0.000E+00 | 0.000E+00 |
| S9 | 0.000E+00 | 0.000E+00 | 0.000E+00 | 0.000E+00 | 0.000E+00 |
| S10 | 0.000E+00 | 0.000E+00 | 0.000E+00 | 0.000E+00 | 0.000E+00 |
| S11 | −1.936E−07 | 0.000E+00 | 0.000E+00 | 0.000E+00 | 0.000E+00 |
| S12 | 6.559E−10 | 0.000E+00 | 0.000E+00 | 0.000E+00 | 0.000E+00 |
| S13 | 2.760E−07 | −9.091E−09 | 1.353E−10 | 0.000E+00 | 0.000E+00 |
| S14 | −4.162E−08 | 1.045E−09 | −1.076E−11 | 0.000E+00 | 0.000E+00 |
| S15 | −5.198E−08 | 1.441E−09 | −1.641E−11 | 0.000E+00 | 0.000E+00 |
| S16 | −9.005E−09 | 1.512E−10 | −1.047E−12 | 0.000E+00 | 0.000E+00 |

FIG. 2b (short focal length) and FIG. 2d (long focal length) illustrate the longitudinal spherical aberration curves, the astigmatic field curves, and the distortion curves of the optical system in this implementation. The longitudinal spherical aberration curve represents focus deviation of lights of different wavelengths after passing through lenses in the optical system. The astigmatic field curve represents sagittal field curvature and tangential field curvature. The distortion curve represents distortion values corresponding to different angles of view. As can be seen from FIG. 2b (short focal length) and FIG. 2d (long focal length), the longitudinal spherical aberration, the astigmatism, and the distortion of the optical system are well controlled, so that the optical system in this implementation has a good image quality.

Third Implementation

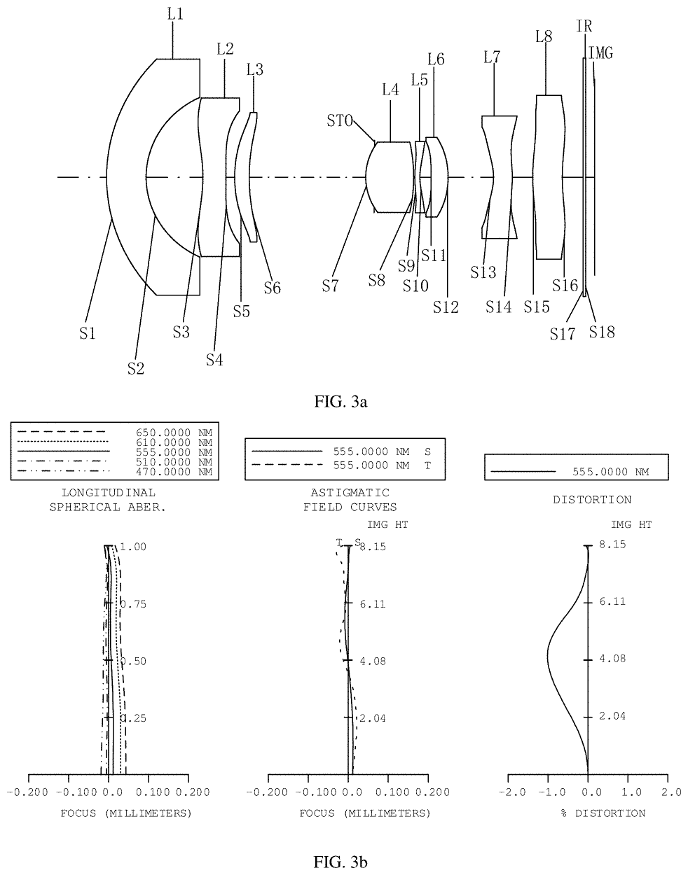

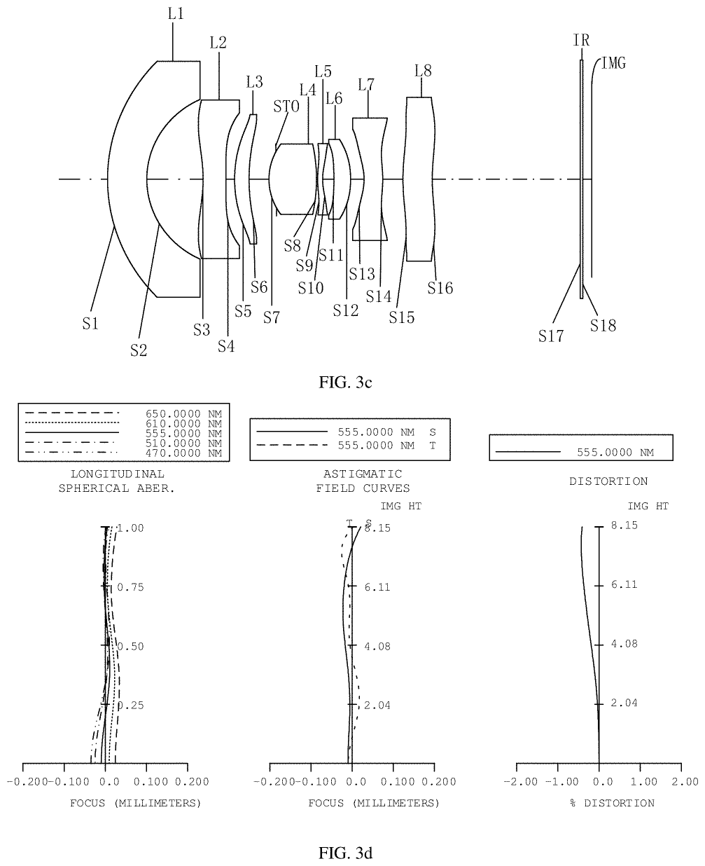

Referring to FIG. 3a and FIG. 3c, an optical system of this implementation includes sequentially from an object side to an image side along an optical axis:

a first lens L1 with a negative refractive power, where the first lens L1 has an object-side surface S1 which is convex both near the optical axis and near a periphery and an image-side surface S2 which is concave both near the optical axis and near a periphery;

a second lens L2 with a negative refractive power, where the second lens L2 has an object-side surface S3 which is concave near the optical axis and convex near a periphery and an image-side surface S4 which is convex near the optical axis and concave near a periphery;

a third lens L3 with a positive refractive power, where the third lens L3 has an object-side surface S5 which is convex near the optical axis and concave near a periphery and an image-side surface S6 which is concave near the optical axis and convex near a periphery;

a fourth lens L4 with a positive refractive power, where the fourth lens L4 has an object-side surface S7 which is convex both near the optical axis and near a periphery and an image-side surface S8 which is convex both near the optical axis and near a periphery;

a fifth lens L5 with a negative refractive power, where the fifth lens L5 has an object-side surface S9 which is convex near the optical axis and concave near a periphery and an image-side surface S10 which is concave both near the optical axis and near a periphery;

a sixth lens L6 with a positive refractive power, where the sixth lens L6 has an object-side surface S11 which is concave both near the optical axis and near a periphery and an image-side surface S12 which is convex both near the optical axis and near a periphery;

a seventh lens L7 with a negative refractive power, where the seventh lens L7 has an object-side surface S13 which is concave both near the optical axis and near a periphery and an image-side surface S14 which is convex both near the optical axis and near a periphery; and

an eighth lens L8 with a positive refractive power, where the eighth lens L8 has an object-side surface S15 which is convex near the optical axis and concave near a periphery and an image-side surface S16 which is concave near the optical axis and convex near a periphery.

Other structures in this implementation are the same as that of the first implementation, and reference may be made to the above.

Table 3a shows characteristics of the optical system of this implementation, where the focal length, material refractive index, and Abbe number are all obtained with visible light with a reference wavelength of 587 nm. The units of Y radius, thickness, and effective focal length are all millimeters (mm). Other parameters have the same meaning as the parameters in the first implementation.

TABLE 3a
Third implementation
EFL = 8.936 mm/18.014 mm; FNO = 2.736, 4.332;
FOV = 84.879 deg/48.865 deg; TTL = 38.5 mm

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | 1.00E+18 | 9.30E+15 | | | | |
| surface | surface | | | | | | | |
| S1 | First | spheric | 14.1982 | 3.1200 | glass | 1.816 | 46.568 | −23.323 |
| S2 | lens L1 | spheric | 7.3287 | 4.4784 | | | | |
| S3 | Second | aspheric | −12.1898 | 1.8185 | plastic | 1.544 | 56.114 | −24.568 |
| S4 | lens L2 | aspheric | −145.6546 | 0.6863 | | | | |
| S5 | Third | aspheric | 10.8923 | 1.1504 | glass | 1.847 | 23.825 | 31.786 |
| S6 | lens L3 | aspheric | 17.4123 | D1 | | | | |
| STO | Stop | | 5.0221 | | | | | |
| S7 | Fourth | spheric | 5.0221 | 3.7801 | glass | 1.438 | 94.575 | 9.002 |
| S8 | lens L4 | spheric | −14.1102 | 0.0900 | | | | |
| S9 | Fifth | aspheric | 8.1108 | 0.4000 | plastic | 1.635 | 23.902 | −20.938 |
| S10 | lens L5 | aspheric | 4.9410 | 0.8883 | | | | |
| S11 | Sixth | aspheric | −42.9264 | 1.3371 | plastic | 1.544 | 56.114 | 16.370 |
| S12 | lens L6 | aspheric | −7.4573 | D2 | | | | |
| S13 | Seventh | aspheric | −4.5189 | 1.4819 | plastic | 1.544 | 56.114 | −17.666 |
| S14 | lens L7 | aspheric | −9.5138 | 1.6122 | | | | |
| S15 | Eighth | aspheric | 18.4626 | 2.3294 | plastic | 1.635 | 23.902 | −454.127 |
| S16 | lens L8 | aspheric | 16.5014 | D3 | | | | |
| S17 | Infrared | spheric | 9.30E+18 | 0.2100 | glass | 1.517 | 64.17 | |
| S18 | cut-off | spheric | 9.30E+18 | 0.7063 | | | | |
| | filter IR | | | | | | | |
| IMG | Imaging | spheric | Infinity | 0.0000 | | | | |
| | surface | | | | | | | |

When the optical system is at the short focal length end, fdj=8.936 mm, FNO=2.736, FOV=84.879 deg, D1=9.188 mm, D2=3.585 mm, D3=1.639 mm. When the optical system is at the long focal length end, fcj=18.014 mm, FNO=4.332, FOV=48.865 deg, D1=11.580 mm, D2=1.068 mm, D3=11.763 mm.

Table 3b shows high-order term coefficients which can be used for the aspheric surfaces in this implementation, where the respective aspheric surface profiles can be limited by the expression given in the first implementation.

TABLE 3b
Third implementation

| Surface number | K | A4 | A6 | A8 | A10 |
|---|---|---|---|---|---|
| S3 | 0.000E+00 | 1.416E−03 | −1.235E−05 | 1.114E−08 | 8.771E−11 |
| S4 | 0.000E+00 | 1.353E−03 | 6.155E−06 | −2.571E−07 | −9.676E−09 |
| S5 | 0.000E+00 | 1.641E−04 | 1.736E−06 | −5.248E−07 | 0.000E+00 |
| S6 | 0.000E+00 | 1.635E−04 | −7.404E−06 | −3.016E−07 | 0.000E+00 |
| S9 | 0.000E+00 | −1.185E−02 | 6.166E−04 | −1.127E−06 | −6.052E−07 |
| S10 | 0.000E+00 | −1.314E−02 | 6.880E−04 | −1.273E−05 | 6.075E−07 |
| S11 | 0.000E+00 | −2.935E−03 | −1.689E−04 | −1.577E−05 | 4.571E−06 |
| S12 | 0.000E+00 | −8.594E−04 | −3.594E−05 | −1.551E−06 | 9.296E−07 |
| S13 | 0.000E+00 | 1.162E−02 | −8.184E−04 | 6.207E−05 | −4.323E−06 |
| S14 | 0.000E+00 | 8.769E−03 | −4.980E−04 | 1.717E−05 | −2.925E−07 |
| S15 | 0.000E+00 | −5.311E−04 | −5.970E−05 | 5.812E−06 | −3.052E−07 |
| S16 | 0.000E+00 | −1.558E−03 | 4.940E−05 | −2.578E−06 | 1.208E−07 |
| Surface number | A12 | A14 | A16 | A18 | A20 |
| S3 | 3.177E−11 | −4.041E−13 | 0.000E+00 | 0.000E+00 | 0.000E+00 |
| S4 | 2.651E−10 | 0.000E+00 | 0.000E+00 | 0.000E+00 | 0.000E+00 |
| S5 | 0.000E+00 | 0.000E+00 | 0.000E+00 | 0.000E+00 | 0.000E+00 |
| S6 | 0.000E+00 | 0.000E+00 | 0.000E+00 | 0.000E+00 | 0.000E+00 |
| S9 | 0.000E+00 | 0.000E+00 | 0.000E+00 | 0.000E+00 | 0.000E+00 |
| S10 | 0.000E+00 | 0.000E+00 | 0.000E+00 | 0.000E+00 | 0.000E+00 |
| S11 | −2.123E−07 | 0.000E+00 | 0.000E+00 | 0.000E+00 | 0.000E+00 |
| S12 | −4.711E−08 | 0.000E+00 | 0.000E+00 | 0.000E+00 | 0.000E+00 |
| S13 | 2.575E−07 | −1.004E−08 | 1.872E−10 | 0.000E+00 | 0.000E+00 |
| S14 | −3.211E−09 | 2.577E−10 | −3.704E−12 | 0.000E+00 | 0.000E+00 |
| S15 | 9.290E−09 | −1.419E−10 | 8.292E−13 | 0.000E+00 | 0.000E+00 |
| S16 | −3.646E−09 | 5.934E−11 | −3.838E−13 | 0.000E+00 | 0.000E+00 |

FIG. 3b (short focal length) and FIG. 3d (long focal length) illustrate the longitudinal spherical aberration curves, the astigmatic field curves, and the distortion curves of the optical system in this implementation. The longitudinal spherical aberration curve represents focus deviation of lights of different wavelengths after passing through lenses in the optical system. The astigmatic field curve represents sagittal field curvature and tangential field curvature. The distortion curve represents distortion values corresponding to different angles of view. As can be seen from FIG. 3b (short focal length) and FIG. 3d (long focal length), the longitudinal spherical aberration, the astigmatism, and the distortion of the optical system are well controlled, so that the optical system in this implementation has a good image quality.

Fourth Implementation

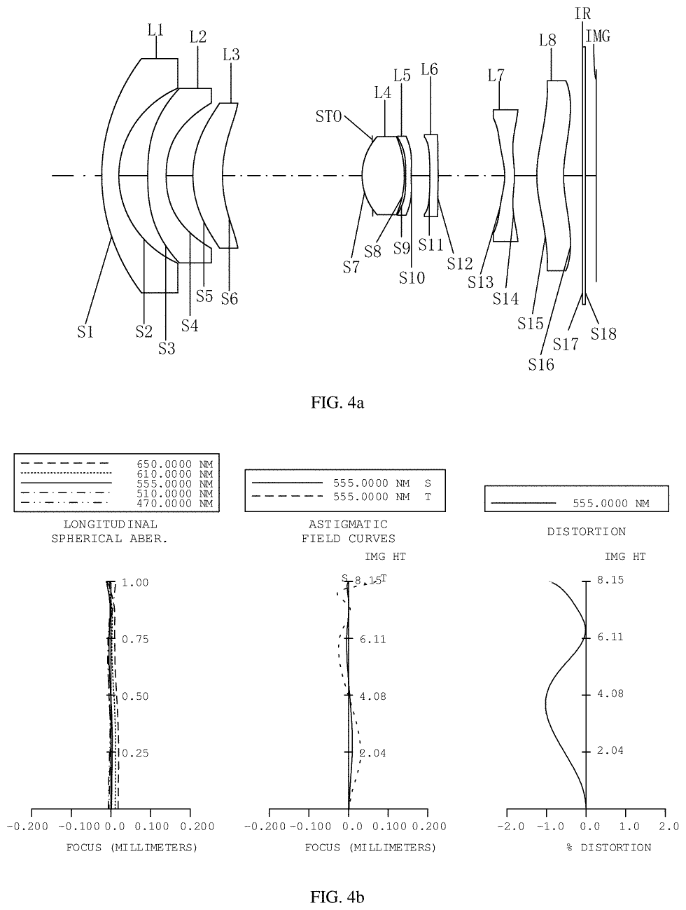

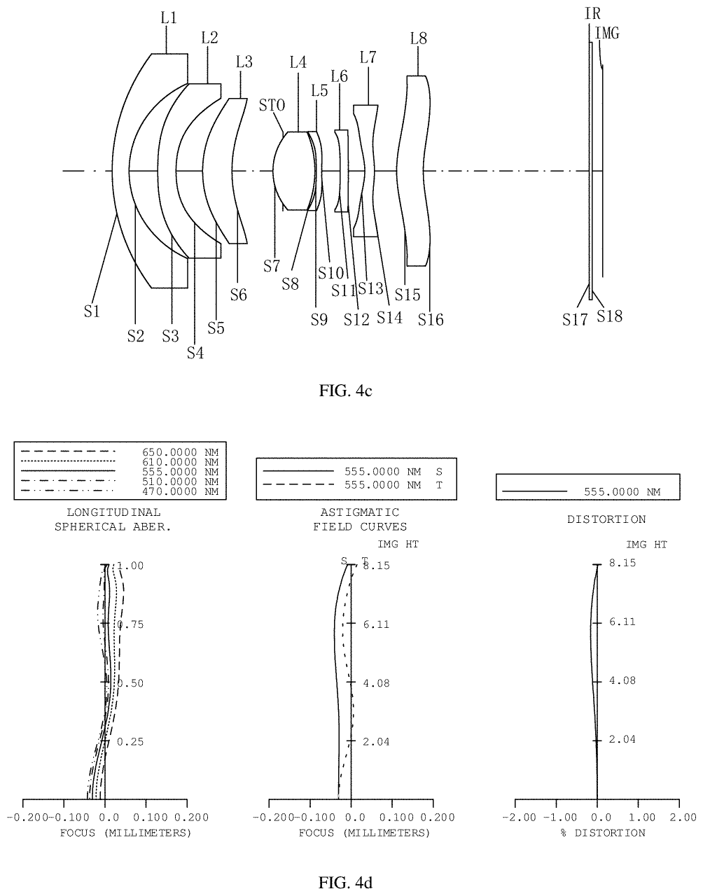

Referring to FIG. 4a and FIG. 4c, an optical system of this implementation includes sequentially from an object side to an image side along an optical axis:

a first lens L1 with a negative refractive power, where the first lens L1 has an object-side surface S1 which is convex both near the optical axis and near a periphery and an image-side surface S2 which is concave both near the optical axis and near a periphery;

a second lens L2 with a negative refractive power, where the second lens L2 has an object-side surface S3 which is convex both the optical axis and convex near a periphery and an image-side surface S4 which is concave both near the optical axis and near a periphery;

a third lens L3 with a positive refractive power, where the third lens L3 has an object-side surface S5 which is convex near the optical axis and concave near a periphery and an image-side surface S6 which is convex near the optical axis and concave near a periphery;

a fourth lens L4 with a positive refractive power, where the fourth lens L4 has an object-side surface S7 which is convex both near the optical axis and near a periphery and an image-side surface S8 which is convex both near the optical axis and near a periphery;

a fifth lens L5 with a negative refractive power, where the fifth lens L5 has an object-side surface S9 which is concave both near the optical axis and near a periphery and an image-side surface S10 which is concave near the optical axis and convex near a periphery;

a sixth lens L6 with a negative refractive power, where the sixth lens L6 has an object-side surface S11 which is concave both near the optical axis and near a periphery and an image-side surface S12 which is convex near the optical axis and concave near a periphery;

a seventh lens L7 with a negative refractive power, where the seventh lens L7 has an object-side surface S13 which is concave both near the optical axis and near a periphery and an image-side surface S14 which is convex both near the optical axis and near a periphery; and

an eighth lens L8 with a positive refractive power, where the eighth lens L8 has an object-side surface S15 which is convex near the optical axis and concave near a periphery and an image-side surface S16 which is concave near the optical axis and convex near a periphery.

Other structures in this implementation are the same as that of the first implementation, and reference may be made to the above.

Table 4a shows characteristics of the optical system of this implementation, where the focal length, material refractive index, and Abbe number are all obtained with visible light with a reference wavelength of 587 nm. The units of Y radius, thickness, and effective focal length are all millimeters (mm). Other parameters have the same meaning as the parameters in the first implementation.

TABLE 4a
Fourth implementation
EFL = 8.237 mm/16.872 mm; FNO = 2.716, 4.299;
FOV = 89.971 deg/51.503 deg; TTL = 36.001 mm

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | 1.00E+18 | 9.30E+15 | | | | |
| surface | surface | | | | | | | |
| S1 | First | spheric | 15.5226 | 1.2416 | glass | 1.816 | 46.568 | −18.823 |
| S2 | lens L1 | spheric | 7.4428 | 2.1012 | | | | |
| S3 | Second | aspheric | 21.5230 | 1.3442 | plastic | 1.544 | 56.114 | −28.023 |
| S4 | lens L2 | aspheric | 8.7284 | 1.9515 | | | | |
| S5 | Third | aspheric | 8.4498 | 2.1543 | glass | 1.847 | 23.825 | 32.959 |
| S6 | lens L3 | aspheric | 10.7030 | D1 | | | | |
| STO | Stop | | 4.6840 | | | | | |
| S7 | Fourth | spheric | 4.6840 | 3.0781 | glass | 1.438 | 94.575 | 7.340 |
| S8 | lens L4 | spheric | −8.1866 | 0.1000 | | | | |
| S9 | Fifth | aspheric | −89.4315 | 0.4059 | plastic | 1.635 | 23.902 | −28.109 |
| S10 | lens L5 | aspheric | 22.3357 | 1.3517 | | | | |
| S11 | Sixth | aspheric | −35.7003 | 0.6000 | plastic | 1.544 | 56.114 | −803.382 |
| S12 | lens L6 | aspheric | −39.1056 | D2 | | | | |
| S13 | Seventh | aspheric | −4.7658 | 0.7073 | plastic | 1.544 | 56.114 | −22.128 |
| S14 | lens L7 | aspheric | −8.3006 | 1.6281 | | | | |
| S15 | Eighth | aspheric | 9.2530 | 1.9561 | plastic | 1.635 | 23.902 | 91.671 |
| S16 | lens L8 | aspheric | 10.0988 | D3 | | | | |
| S17 | Infrared | spheric | 9.30E+18 | 0.2100 | glass | 1.517 | 64.17 | |
| S18 | cut-off | spheric | 9.30E+18 | 0.7809 | | | | |
| | filter IR | | | | | | | |
| IMG | Imaging | spheric | Infinity | 0.0000 | | | | |
| | surface | | | | | | | |

When the optical system is at the short focal length end, fdj=8.237 mm, FNO=2.716, FOV=89.971 deg, D1=10.164 mm, D2=4.850 mm, D3=1.376 mm. When the optical system is at the long focal length end, fcj=16.872 mm, FNO=4.299, FOV=51.503 deg, D1=3.006 mm, D2=1.204 mm, D3=12.179 mm.

Table 4b shows high-order term coefficients which can be used for the aspheric surfaces in this implementation, where the respective aspheric surface profiles can be limited by the expression given in the first implementation.

TABLE 4b
Fourth implementation

| Surface number | K | A4 | A6 | A8 | A10 |
|---|---|---|---|---|---|
| S3 | 0.000E+00 | 1.421E−03 | −4.582E−05 | 1.245E−06 | −2.170E−08 |
| S4 | 0.000E+00 | 2.284E−03 | −5.956E−05 | 1.147E−06 | −9.505E−09 |
| S5 | 0.000E+00 | 3.027E−04 | −1.690E−05 | 5.460E−08 | 0.000E+00 |
| S6 | 0.000E+00 | −3.935E−05 | −1.573E−05 | 5.938E−08 | 0.000E+00 |
| S9 | 0.000E+00 | −1.287E−02 | 8.366E−04 | −1.931E−05 | −1.272E−07 |
| S10 | 0.000E+00 | −1.323E−02 | 9.677E−04 | −3.489E−05 | 4.154E−07 |
| S11 | 0.000E+00 | 3.693E−04 | −3.881E−04 | 5.515E−06 | −1.705E−06 |
| S12 | 0.000E+00 | 3.107E−03 | −2.238E−04 | −6.508E−06 | −6.278E−07 |
| S13 | 0.000E+00 | 1.346E−02 | −9.781E−04 | 5.977E−05 | −3.471E−06 |
| S14 | 0.000E+00 | 1.013E−02 | −5.304E−04 | 7.903E−06 | 6.283E−07 |
| S15 | 0.000E+00 | −2.596E−03 | 1.426E−04 | −8.420E−06 | 3.453E−07 |
| S16 | 0.000E+00 | −2.583E−03 | 1.238E−04 | −6.318E−06 | 2.317E−07 |
| Surface number | A12 | A14 | A16 | A18 | A20 |
| S3 | 2.081E−10 | −8.376E−13 | 0.000E+00 | 0.000E+00 | 0.000E+00 |
| S4 | 2.806E−11 | 0.000E+00 | 0.000E+00 | 0.000E+00 | 0.000E+00 |
| S5 | 0.000E+00 | 0.000E+00 | 0.000E+00 | 0.000E+00 | 0.000E+00 |
| S6 | 0.000E+00 | 0.000E+00 | 0.000E+00 | 0.000E+00 | 0.000E+00 |
| S9 | 0.000E+00 | 0.000E+00 | 0.000E+00 | 0.000E+00 | 0.000E+00 |
| S10 | 0.000E+00 | 0.000E+00 | 0.000E+00 | 0.000E+00 | 0.000E+00 |
| S11 | 6.274E−08 | 0.000E+00 | 0.000E+00 | 0.000E+00 | 0.000E+00 |
| S12 | 1.232E−07 | 0.000E+00 | 0.000E+00 | 0.000E+00 | 0.000E+00 |
| S13 | 1.849E−07 | −6.707E−09 | 1.176E−10 | 0.000E+00 | 0.000E+00 |
| S14 | −4.312E−08 | 1.135E−09 | −1.142E−11 | 0.000E+00 | 0.000E+00 |
| S15 | −8.713E−09 | 1.208E−10 | −7.022E−13 | 0.000E+00 | 0.000E+00 |
| S16 | −5.320E−09 | 6.647E−11 | −3.425E−13 | 0.000E+00 | 0.000E+00 |

FIG. 4b (short focal length) and FIG. 4d (long focal length) illustrate the longitudinal spherical aberration curves, the astigmatic field curves, and the distortion curves of the optical system in this implementation. The longitudinal spherical aberration curve represents focus deviation of lights of different wavelengths after passing through lenses in the optical system. The astigmatic field curve represents sagittal field curvature and tangential field curvature. The distortion curve represents distortion values corresponding to different angles of view. As can be seen from FIG. 4b (short focal length) and FIG. 4d (long focal length), the longitudinal spherical aberration, the astigmatism, and the distortion of the optical system are well controlled, so that the optical system in this implementation has a good image quality.

Fifth Implementation

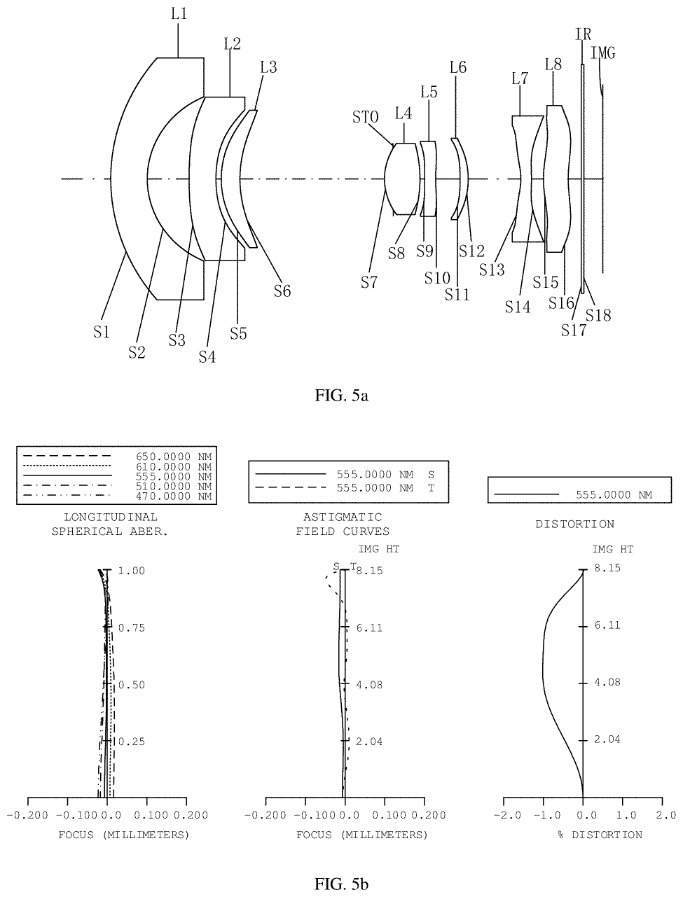

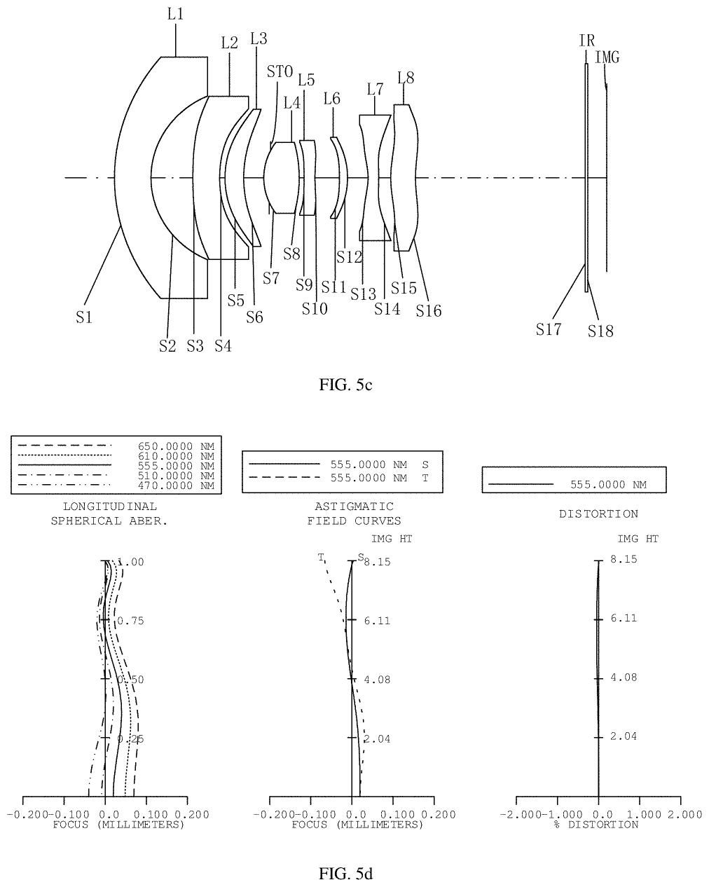

Referring to FIG. 5a and FIG. 5c, an optical system of this implementation includes sequentially from an object side to an image side along an optical axis:

a first lens L1 with a negative refractive power, where the first lens L1 has an object-side surface S2 which is convex both near the optical axis and near a periphery and an image-side surface S2 which is concave both near the optical axis and near a periphery;

a second lens L2 with a negative refractive power, where the second lens L2 has an object-side surface S3 which is convex both the optical axis and convex near a periphery and an image-side surface S4 which is concave both near the optical axis and near a periphery;

a third lens L3 with a positive refractive power, where the third lens L3 has an object-side surface S5 which is convex near the optical axis and concave near a periphery and an image-side surface S6 which is concave near the optical axis and convex near a periphery;

a fourth lens L4 with a positive refractive power, where the fourth lens L4 has an object-side surface S7 which is convex both near the optical axis and near a periphery and an image-side surface S8 which is convex both near the optical axis and near a periphery;

a fifth lens L5 with a negative refractive power, where the fifth lens L5 has an object-side surface S9 which is convex near the optical axis and concave near a periphery and an image-side surface S10 which is concave near the optical axis and convex near a periphery;

a sixth lens L6 with a positive refractive power, where the sixth lens L6 has an object-side surface S11 which is concave both near the optical axis and near a periphery and an image-side surface S12 which is convex near the optical axis and concave near a periphery;

a seventh lens L7 with a negative refractive power, where the seventh lens L7 has an object-side surface S13 which is concave both near the optical axis and near a periphery and an image-side surface S14 which is convex both near the optical axis and near a periphery; and

an eighth lens L8 with a positive refractive power, where the eighth lens L8 has an object-side surface S15 which is convex near the optical axis and concave near a periphery and an image-side surface S16 which is concave near the optical axis and convex near a periphery.

Other structures in this implementation are the same as that of the first implementation, and reference may be made to the above.

Table 5a shows characteristics of the optical system of this implementation, where the focal length, material refractive index, and Abbe number are all obtained with visible light with a reference wavelength of 587 nm. The units of Y radius, thickness, and effective focal length are all millimeters (mm). Other parameters have the same meaning as the parameters in the first implementation.

TABLE 5a
Fifth implementation
EFL = 8.915 mm/23.328 mm; FNO = 2.735/5.003;
FOV = 84.887 deg/38.574 deg; TTL = 40.45 mm

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | 1.00E+18 | 9.30E+15 | | | | |
| surface | surface | | | | | | | |
| S1 | First | spheric | 16.3335 | 3.0000 | glass | 1.816 | 46.568 | −21.503 |
| S2 | lens L1 | spheric | 7.7611 | 3.4383 | | | | |
| S3 | Second | aspheric | 34.9271 | 2.2058 | plastic | 1.544 | 56.114 | −30.889 |
| S4 | lens L2 | aspheric | 11.0942 | 0.4392 | | | | |
| S5 | Third | aspheric | 8.1873 | 1.5355 | glass | 1.847 | 23.825 | 31.682 |
| S6 | lens L3 | aspheric | 10.7708 | D1 | | | | |
| STO | Stop | | 5.3083 | | | | | |
| S7 | Fourth | spheric | 5.3083 | 2.9107 | glass | 1.438 | 94.575 | 8.859 |
| S8 | lens L4 | spheric | −11.9955 | 0.3918 | | | | |
| S9 | Fifth | aspheric | 511.8530 | 0.9053 | plastic | 1.635 | 23.902 | −24.140 |
| S10 | lens L5 | aspheric | 14.8714 | 2.0116 | | | | |
| S11 | Sixth | aspheric | −17.7431 | 0.6595 | plastic | 1.544 | 56.114 | 22.193 |
| S12 | lens L6 | aspheric | −7.2793 | D2 | | | | |
| S13 | Seventh | aspheric | −4.9485 | 0.8772 | plastic | 1.544 | 56.114 | −13.651 |
| S14 | lens L7 | aspheric | −15.7523 | 0.9831 | | | | |
| S15 | Eighth | aspheric | 9.0204 | 2.0346 | plastic | 1.635 | 23.902 | 50.904 |
| S16 | lens L8 | aspheric | 11.4166 | D3 | | | | |
| S17 | Infrared | spheric | 9.30E+18 | 0.2100 | glass | 1.517 | 64.17 | |
| S18 | cut-off | spheric | 9.30E+18 | 1.5622 | | | | |
| | filter IR | | | | | | | |
| IMG | Imaging | spheric | Infinity | 0.0000 | | | | |
| | surface | | | | | | | |

When the optical system is at the short focal length end, fdj=8.915 mm, FNO=2.735, FOV=84.887 deg, D1=11.880 mm, D2=4.326 mm, D3=1.079 mm. When the optical system is at the long focal length end, fcj=23.328 mm, FNO=5.003, FOV=38.574 deg, D1=1.650 mm, D2=1.690 mm, D3=13.945 mm.

Table 5b shows high-order term coefficients which can be used for the aspheric surfaces in this implementation, where the respective aspheric surface profiles can be limited by the expression given in the first implementation.

TABLE 5b
Fifth implementation

| Surface number | K | A4 | A6 | A8 | A10 |
|---|---|---|---|---|---|
| S3 | 0.000E+00 | 2.053E−04 | 1.053E−05 | −4.110E−07 | 6.965E−09 |
| S4 | 0.000E+00 | 5.944E−04 | 1.243E−05 | −5.400E−07 | 8.886E−10 |
| S5 | 0.000E+00 | 1.806E−04 | −7.166E−06 | −9.916E−08 | 0.000E+00 |
| S6 | 0.000E+00 | −1.654E−05 | −8.771E−06 | 2.372E−08 | 0.000E+00 |
| S9 | 0.000E+00 | −5.324E−03 | 1.595E−04 | −2.264E−06 | 1.312E−07 |
| S10 | 0.000E+00 | −5.643E−03 | 2.303E−04 | −7.391E−06 | 2.189E−07 |
| S11 | 0.000E+00 | −2.727E−03 | −5.462E−05 | 6.988E−06 | −8.295E−07 |
| S12 | 0.000E+00 | −4.056E−04 | −1.675E−05 | 8.076E−06 | −7.931E−07 |
| S13 | 0.000E+00 | 1.589E−02 | −1.616E−03 | 1.402E−04 | −9.273E−06 |
| S14 | 0.000E+00 | 1.102E−02 | −8.755E−04 | 4.407E−05 | −1.500E−06 |
| S15 | 0.000E+00 | −4.055E−03 | 2.232E−04 | −1.188E−05 | 2.986E−07 |
| S16 | 0.000E+00 | −3.563E−03 | 1.737E−04 | −9.710E−06 | 3.866E−07 |
| Surface number | A12 | A14 | A16 | A18 | A20 |
| S3 | −6.986E−11 | 3.227E−13 | 0.000E+00 | 0.000E+00 | 0.000E+00 |
| S4 | 5.287E−11 | 0.000E+00 | 0.000E+00 | 0.000E+00 | 0.000E+00 |
| S5 | 0.000E+00 | 0.000E+00 | 0.000E+00 | 0.000E+00 | 0.000E+00 |
| S6 | 0.000E+00 | 0.000E+00 | 0.000E+00 | 0.000E+00 | 0.000E+00 |
| S9 | 0.000E+00 | 0.000E+00 | 0.000E+00 | 0.000E+00 | 0.000E+00 |
| S10 | 0.000E+00 | 0.000E+00 | 0.000E+00 | 0.000E+00 | 0.000E+00 |
| S11 | 3.405E−08 | 0.000E+00 | 0.000E+00 | 0.000E+00 | 0.000E+00 |
| S12 | 4.230E−08 | 0.000E+00 | 0.000E+00 | 0.000E+00 | 0.000E+00 |
| S13 | 4.239E−07 | −1.155E−08 | 1.433E−10 | 0.000E+00 | 0.000E+00 |
| S14 | 3.309E−08 | −4.141E−10 | 2.126E−12 | 0.000E+00 | 0.000E+00 |
| S15 | 1.285E−10 | −1.102E−10 | 1.097E−12 | 0.000E+00 | 0.000E+00 |
| S16 | −1.049E−08 | 1.770E−10 | −1.317E−12 | 0.000E+00 | 0.000E+00 |

FIG. 5b (short focal length) and FIG. 5d (long focal length) illustrate the longitudinal spherical aberration curves, the astigmatic field curves, and the distortion curves of the optical system in this implementation. The longitudinal spherical aberration curve represents focus deviation of lights of different wavelengths after passing through lenses in the optical system. The astigmatic field curve represents sagittal field curvature and tangential field curvature. The distortion curve represents distortion values corresponding to different angles of view. As can be seen from FIG. 5b (short focal length) and FIG. 5d (long focal length), the longitudinal spherical aberration, the astigmatism, and the distortion of the optical system are well controlled, so that the optical system in this implementation has a good image quality.

Sixth Implementation

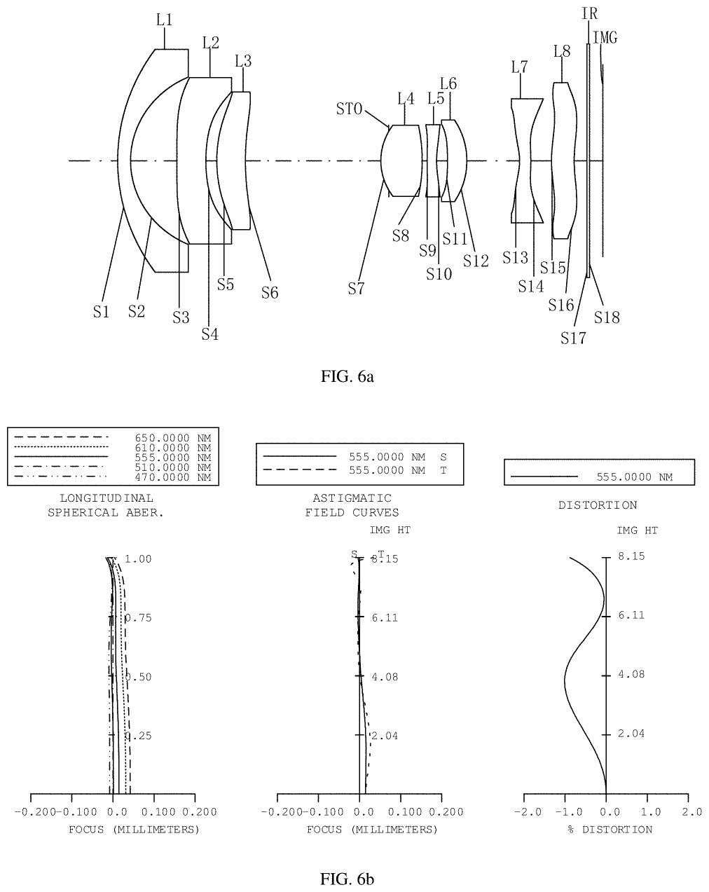

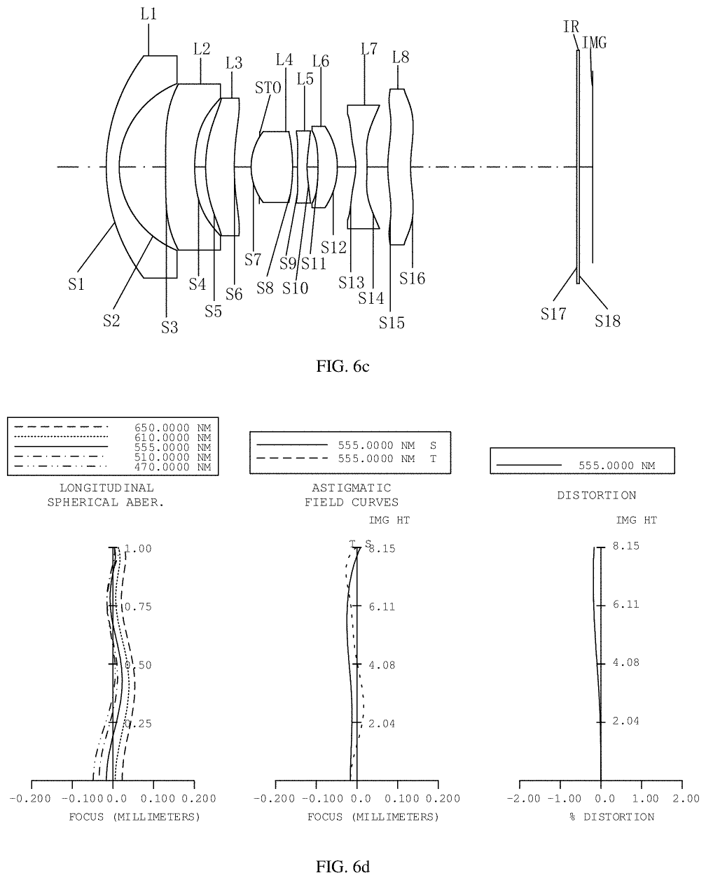

Referring to FIG. 6a and FIG. 6c, an optical system of this implementation includes sequentially from an object side to an image side along an optical axis:

a first lens L1 with a negative refractive power, where the first lens L1 has an object-side surface S1 which is convex both near the optical axis and near a periphery and an image-side surface S2 which is concave both near the optical axis and near a periphery;

a second lens L2 with a negative refractive power, where the second lens L2 has an object-side surface S3 which is convex both the optical axis and convex near a periphery and an image-side surface S4 which is concave both near the optical axis and near a periphery;

a third lens L3 with a positive refractive power, where the third lens L3 has an object-side surface S5 which is convex near the optical axis and concave near a periphery and an image-side surface S6 which is concave near the optical axis and convex near a periphery;

a fourth lens L4 with a positive refractive power, where the fourth lens L4 has an object-side surface S7 which is convex both near the optical axis and near a periphery and an image-side surface S8 which is convex both near the optical axis and near a periphery;

a fifth lens L5 with a negative refractive power, where the fifth lens L5 has an object-side surface S9 which is convex near the optical axis and concave near a periphery and an image-side surface S10 which is concave both near the optical axis and near a periphery;

a sixth lens L6 with a positive refractive power, where the sixth lens L6 has an object-side surface S11 which is concave both near the optical axis and near a periphery and an image-side surface S12 which is convex both near the optical axis and near a periphery;

a seventh lens L7 with a negative refractive power, where the seventh lens L7 has an object-side surface S13 which is concave both near the optical axis and near a periphery and an image-side surface S14 which is convex both near the optical axis and near a periphery; and

an eighth lens L8 with a positive refractive power, where the eighth lens L8 has an object-side surface S15 which is convex both near the optical axis and near a periphery and an image-side surface S16 which is concave both near the optical axis and near a periphery.

Other structures in this implementation are the same as that of the first implementation, and reference may be made to the above.

Table 6a shows characteristics of the optical system of this implementation, where the focal length, material refractive index, and Abbe number are all obtained with visible light with a reference wavelength of 587 nm. The units of Y radius, thickness, and effective focal length are all millimeters (mm). Other parameters have the same meaning as the parameters in the first implementation.

TABLE 6a
Sixth implementation
EFL = 7.814 mm/19.019 mm; FNO = 2.642, 4.708;
FOV = 93.05 deg/46.458 deg; TTL = 39.1 mm

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | 1.00E+18 | 9.30E+15 | | | | |
| surface | surface | | | | | | | |
| S1 | First | spheric | 1.63E+01 | 1.0417 | glass | 1.816 | 46.568 | −19.128 |
| S2 | lens L1 | spheric | 7.75E+00 | 3.7304 | | | | |
| S3 | Second | aspheric | 2.96E+03 | 2.3385 | plastic | 1.544 | 56.114 | −26.483 |
| S4 | lens L2 | aspheric | 14.3357 | 0.8799 | | | | |
| S5 | Third | aspheric | 1.22E+01 | 2.3038 | glass | 1.847 | 23.825 | 28.304 |
| S6 | lens L3 | aspheric | 22.8683 | D1 | | | | |
| STO | Stop | | 5.1754 | | | | | |
| S7 | Fourth | spheric | 5.1754 | 3.3338 | glass | 1.438 | 94.575 | 9.256 |
| S8 | lens L4 | spheric | −15.0132 | 0.3906 | | | | |
| S9 | Fifth | aspheric | 22.4010 | 0.7700 | plastic | 1.635 | 23.902 | −20.259 |
| S10 | lens L5 | aspheric | 8.0619 | 0.8792 | | | | |
| S11 | Sixth | aspheric | −30.4387 | 1.5576 | plastic | 1.544 | 56.114 | 15.943 |
| S12 | lens L6 | aspheric | −6.87E+00 | D2 | | | | |
| S13 | Seventh | aspheric | −4.83E+00 | 0.9111 | plastic | 1.544 | 56.114 | −14.612 |
| S14 | lens L7 | aspheric | −1.32E+01 | 1.6619 | | | | |
| S15 | Eighth | aspheric | 1.11E+01 | 1.8303 | plastic | 1.635 | 23.902 | 128.883 |
| S16 | lens L8 | aspheric | 1.21E+01 | D3 | | | | |
| S17 | Infrared | spheric | 9.30E+18 | 0.2100 | glass | 1.517 | 64.17 | |
| S18 | cut-off | spheric | 9.30E+18 | 1.0748 | | | | |
| | filter IR | | | | | | | |
| IMG | Imaging | spheric | Infinity | 0.0000 | | | | |
| | surface | | | | | | | |

When the optical system is at the short focal length end, fdj=7.814 mm, FNO=2.642, FOV=93.05 deg, D1=10.915 mm, D2=4.249 mm, D3=1.023 mm. When the optical system is at the long focal length end, fcj=19.019 mm, FNO=4.708, FOV=46.458 deg, D1=1.350 mm, D2=1.480 mm, D3=13.356 mm.

Table 6b shows high-order term coefficients which can be used for the aspheric surfaces in this implementation, where the respective aspheric surfaces profiles can be limited by the expression given in the first implementation.

TABLE 6b
Sixth implementation

| Surface number | K | A4 | A6 | A8 | A10 |
|---|---|---|---|---|---|
| S3 | 0.000E+00 | 4.285E−04 | 3.460E−06 | −1.286E−07 | 1.485E−09 |
| S4 | 0.000E+00 | 7.795E−04 | 3.468E−06 | −3.623E−08 | −5.288E−09 |
| S5 | 0.000E+00 | 1.966E−04 | −9.242E−06 | −5.961E−08 | 0.000E+00 |
| S6 | 0.000E+00 | 2.294E−05 | −1.312E−05 | 7.779E−08 | 0.000E+00 |
| S9 | 0.000E+00 | −5.516E−03 | 2.136E−04 | −1.314E−06 | 3.618E−08 |
| S10 | 0.000E+00 | −6.322E−03 | 3.005E−04 | −5.000E−06 | 2.678E−07 |
| S11 | 0.000E+00 | −3.319E−03 | −3.778E−05 | −1.277E−06 | 9.302E−07 |
| S12 | 0.000E+00 | −6.382E−04 | −2.494E−06 | 3.133E−06 | −2.164E−07 |
| S13 | 0.000E+00 | 1.469E−02 | −1.298E−03 | 1.034E−04 | −6.590E−06 |
| S14 | 0.000E+00 | 1.097E−02 | −7.684E−04 | 3.514E−05 | −1.098E−06 |
| S15 | 0.000E+00 | −2.986E−03 | 1.241E−04 | −5.600E−06 | 1.111E−07 |
| S16 | 0.000E+00 | −3.004E−03 | 1.326E−04 | −7.180E−06 | 2.769E−07 |
| Surface number | A12 | A14 | A16 | A18 | A20 |
| S3 | −9.413E−12 | 4.239E−15 | 0.000E+00 | 0.000E+00 | 0.000E+00 |
| S4 | 3.786E−11 | 0.000E+00 | 0.000E+00 | 0.000E+00 | 0.000E+00 |
| S5 | 0.000E+00 | 0.000E+00 | 0.000E+00 | 0.000E+00 | 0.000E+00 |
| S6 | 0.000E+00 | 0.000E+00 | 0.000E+00 | 0.000E+00 | 0.000E+00 |
| S9 | 0.000E+00 | 0.000E+00 | 0.000E+00 | 0.000E+00 | 0.000E+00 |
| S10 | 0.000E+00 | 0.000E+00 | 0.000E+00 | 0.000E+00 | 0.000E+00 |
| S11 | −6.248E−08 | 0.000E+00 | 0.000E+00 | 0.000E+00 | 0.000E+00 |
| S12 | 9.364E−09 | 0.000E+00 | 0.000E+00 | 0.000E+00 | 0.000E+00 |
| S13 | 3.064E−07 | −8.778E−09 | 1.183E−10 | 0.000E+00 | 0.000E+00 |
| S14 | 2.143E−08 | −2.053E−10 | 3.491E−13 | 0.000E+00 | 0.000E+00 |
| S15 | 1.417E−09 | −7.482E−11 | 6.756E−13 | 0.000E+00 | 0.000E+00 |
| S16 | −6.780E−09 | 9.533E−11 | −5.681E−13 | 0.000E+00 | 0.000E+00 |

FIG. 6b (short focal length) and FIG. 6d (long focal length) illustrate the longitudinal spherical aberration curves, the astigmatic field curves, and the distortion curves of the optical system in this implementation. The longitudinal spherical aberration curve represents focus deviation of lights of different wavelengths after passing through lenses in the optical system. The astigmatic field curve represents sagittal field curvature and tangential field curvature. The distortion curve represents distortion values corresponding to different angles of view. As can be seen from FIG. 6b (short focal length) and FIG. 6d (long focal length), the longitudinal spherical aberration, the astigmatism, and the distortion of the optical system are well controlled, so that the optical system in this implementation has a good image quality.

Seventh Implementation

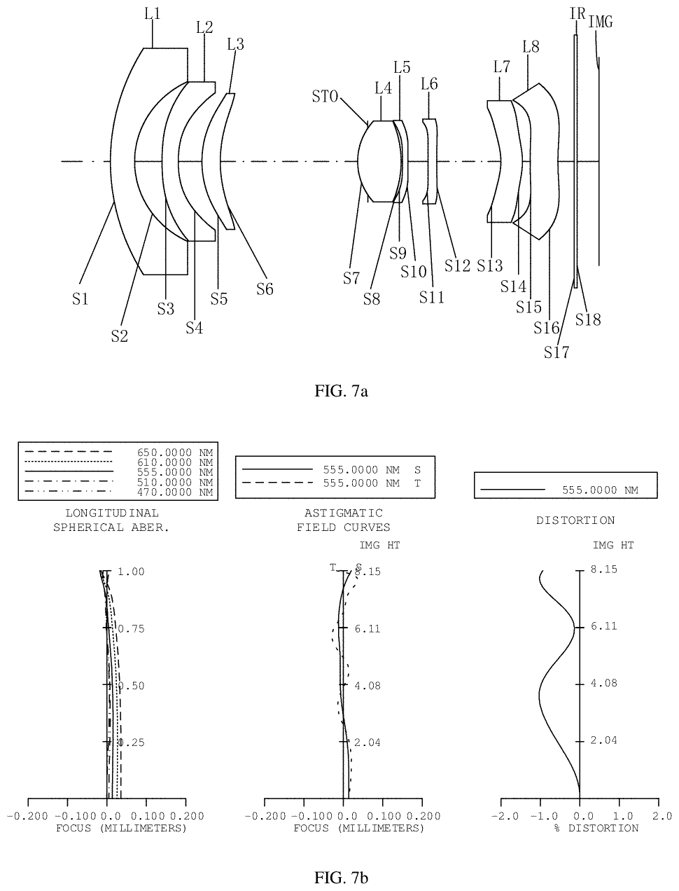

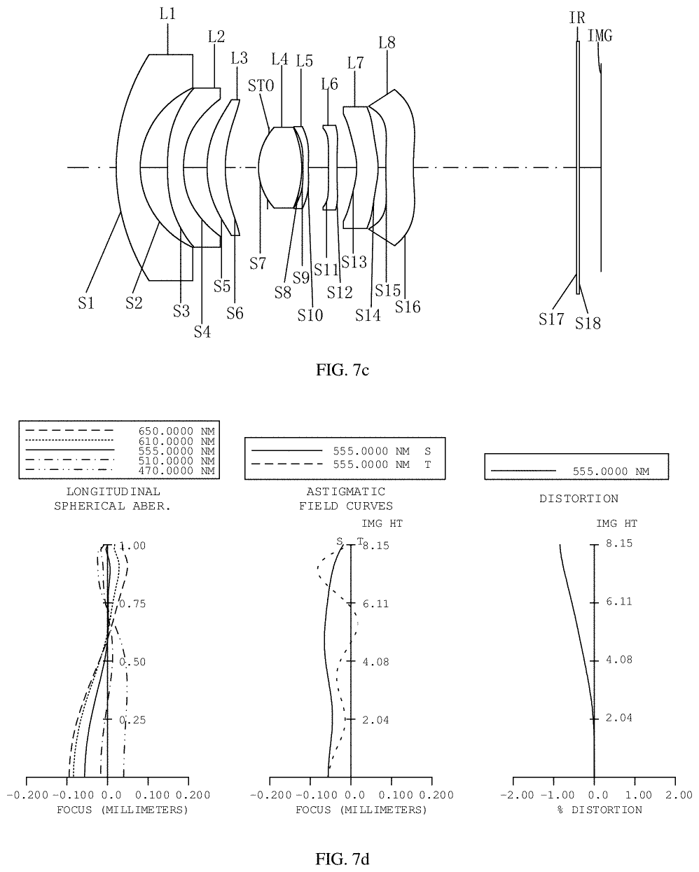

Referring to FIG. 7a and FIG. 7c, an optical system of this implementation includes sequentially from an object side to an image side along an optical axis:

a first lens L1 with a negative refractive power, where the first lens L1 has an object-side surface S1 which is convex both near the optical axis and near a periphery and an image-side surface S2 which is concave both near the optical axis and near a periphery;

a second lens L2 with a negative refractive power, where the second lens L2 has an object-side surface S3 which is convex both the optical axis and convex near a periphery and an image-side surface S4 which is concave both near the optical axis and near a periphery;

a third lens L3 with a positive refractive power, where the third lens L3 has an object-side surface S5 which is convex near the optical axis and concave near a periphery and an image-side surface S6 which is concave near the optical axis and convex near a periphery;

a fourth lens L4 with a positive refractive power, where the fourth lens L4 has an object-side surface S7 which is convex both near the optical axis and near a periphery and an image-side surface S8 which is convex both near the optical axis and near a periphery;

a fifth lens L5 with a negative refractive power, where the fifth lens L5 has an object-side surface S9 which is concave both near the optical axis and near a periphery and an image-side surface S10 which is concave near the optical axis and convex near a periphery;

a sixth lens L6 with a positive refractive power, where the sixth lens L6 has an object-side surface S11 which is convex near the optical axis and concave near a periphery and an image-side surface S12 which is concave both near the optical axis and near a periphery;

a seventh lens L7 with a negative refractive power, where the seventh lens L7 has an object-side surface S13 which is concave both near the optical axis and near a periphery and an image-side surface S14 which is convex near the optical axis and concave near a periphery; and

an eighth lens L8 with a negative refractive power, where the eighth lens L8 has an object-side surface S15 which is convex both near the optical axis and near a periphery and an image-side surface S16 which is concave near the optical axis and convex near a periphery.

Other structures in this implementation are the same as that of the first implementation, and reference may be made to the above.

Table 7a shows characteristics of the optical system of this implementation, where the focal length, material refractive index, and Abbe number are all obtained with visible light with a reference wavelength of 587 nm. The units of Y radius, thickness, and effective focal length are all millimeters (mm). Other parameters have the same meaning as the parameters in the first implementation.

TABLE 7a
Seventh implementation
EFL = 8.189 mm/16.975 mm; FNO = 2.665, 4.164;
FOV = 90.351 deg/51.506 deg; TTL = 36.25 mm

| Surface | Surface | Surface | | | | Refractive | Abbe | Focal |
|---|---|---|---|---|---|---|---|---|
| number | name | type | Y radius | Thickness | Material | index | number | length |
| Object | Object | spheric | 1.00E+18 | 9.30E+15 | | | | |
| surface | surface | | | | | | | |
| S1 | First | spheric | 1.73E+01 | 1.7957 | glass | 1.816 | 46.568 | −15.496 |
| S2 | lens L1 | spheric | 6.96E+00 | 2.0362 | | | | |
| S3 | Second | aspheric | 2.02E+01 | 1.2033 | plastic | 1.544 | 56.114 | −30.820 |
| S4 | lens L2 | aspheric | 8.9777 | 1.7562 | | | | |
| S5 | Third | aspheric | 8.1030 | 1.3635 | glass | 1.847 | 23.825 | 31.789 |
| S6 | lens L3 | aspheric | 10.6989 | D1 | | | | |
| STO | Stop | | 4.8840 | | | | | |
| S7 | Fourth | spheric | 4.8840 | 3.2265 | glass | 1.438 | 94.575 | 7.626 |
| S8 | lens L4 | spheric | −8.4281 | 0.1000 | | | | |
| S9 | Fifth | aspheric | −2.33E+02 | 0.4000 | plastic | 1.635 | 23.902 | −32.045 |
| S10 | lens L5 | aspheric | 2.23E+01 | 1.4982 | | | | |
| S11 | Sixth | aspheric | 912.5600 | 0.6468 | plastic | 1.544 | 56.114 | 129104.090 |
| S12 | lens L6 | aspheric | 9.24E+02 | D2 | | | | |
| S13 | Seventh | aspheric | −4.84E+00 | 1.5991 | plastic | 1.544 | 56.114 | 1038.627 |
| S14 | lens L7 | aspheric | −5.35E+00 | 0.5756 | | | | |
| S15 | Eighth | aspheric | 8.28E+01 | 2.0569 | plastic | 1.635 | 23.902 | −36.650 |
| S16 | lens L8 | aspheric | 1.80E+01 | D3 | | | | |
| S17 | Infrared | spheric | 9.30E+18 | 0.2100 | glass | 1.517 | 64.166 | |
| S18 | cut-off | spheric | 9.30E+18 | 1.6246 | | | | |
| | filter IR | | | | | | | |
| IMG | Imaging | spheric | Infinity | 0.0000 | | | | |
| | surface | | | | | | | |

When the optical system is at the short focal length end, fdj=8.189 mm, FNO=2.665, FOV=90.351 deg, D1=10.189 mm, D2=4.758 mm, D3=1.210 mm. When the optical system is at the long focal length end, fcj=16.975 mm, FNO=4.164, FOV=51.506 deg, D1=2.485 mm, D2=1.473 mm, D3=12.200 mm.

Table 7b shows high-order term coefficients which can be used for the aspheric surfaces in this implementation, where the respective aspheric surface profiles can be limited by the expression given in the first implementation.

TABLE 7b
Seventh implementation

| Surface number | K | A4 | A6 | A8 | A10 |
|---|---|---|---|---|---|
| S3 | 0.000E+00 | 1.560E−03 | −5.548E−05 | 1.665E−06 | −3.589E−08 |
| S4 | 0.000E+00 | 2.407E−03 | −7.413E−05 | 1.977E−06 | −6.769E−08 |
| S5 | 0.000E+00 | 2.922E−04 | −1.277E−05 | −1.886E−07 | 0.000E+00 |
| S6 | 0.000E+00 | −5.727E−05 | −7.117E−06 | −2.233E−07 | 0.000E+00 |
| S9 | 0.000E+00 | −1.219E−02 | 6.598E−04 | −6.617E−06 | −3.671E−07 |
| S10 | 0.000E+00 | −1.222E−02 | 7.498E−04 | −1.816E−05 | 3.635E−08 |
| S11 | 0.000E+00 | 1.316E−03 | −6.452E−04 | 1.584E−05 | −1.804E−06 |
| S12 | 0.000E+00 | 3.453E−03 | −4.602E−04 | −8.806E−06 | 1.084E−06 |
| S13 | 0.000E+00 | 9.804E−03 | −6.306E−04 | 9.301E−06 | 4.251E−06 |
| S14 | 0.000E+00 | 1.308E−02 | −1.229E−03 | 7.335E−05 | −1.938E−06 |
| S15 | 0.000E+00 | 3.290E−03 | −9.618E−04 | 1.102E−04 | −9.686E−06 |
| S16 | 0.000E+00 | −2.552E−03 | 1.030E−04 | −1.047E−05 | 6.784E−07 |
| Surface number | A12 | A14 | A16 | A18 | A20 |
| S3 | 3.902E−10 | −5.134E−13 | 0.000E+00 | 0.000E+00 | 0.000E+00 |
| S4 | 1.201E−09 | 0.000E+00 | 0.000E+00 | 0.000E+00 | 0.000E+00 |
| S5 | 0.000E+00 | 0.000E+00 | 0.000E+00 | 0.000E+00 | 0.000E+00 |
| S6 | 0.000E+00 | 0.000E+00 | 0.000E+00 | 0.000E+00 | 0.000E+00 |
| S9 | 0.000E+00 | 0.000E+00 | 0.000E+00 | 0.000E+00 | 0.000E+00 |
| S10 | 0.000E+00 | 0.000E+00 | 0.000E+00 | 0.000E+00 | 0.000E+00 |
| S11 | 7.380E−08 | 0.000E+00 | 0.000E+00 | 0.000E+00 | 0.000E+00 |
| S12 | 2.240E−08 | 0.000E+00 | 0.000E+00 | 0.000E+00 | 0.000E+00 |
| S13 | −4.681E−07 | 2.003E−08 | −3.043E−10 | 0.000E+00 | 0.000E+00 |
| S14 | −1.161E−08 | 1.379E−09 | −1.097E−11 | 0.000E+00 | 0.000E+00 |
| S15 | 5.631E−07 | −1.837E−08 | 2.463E−10 | 0.000E+00 | 0.000E+00 |
| S16 | −2.345E−08 | 3.979E−10 | −2.605E−12 | 0.000E+00 | 0.000E+00 |

FIG. 7b (short focal length) and FIG. 7d (long focal length) illustrate the longitudinal spherical aberration curves, the astigmatic field curves, and the distortion curves of the optical system in this implementation. The longitudinal spherical aberration curve represents focus deviation of lights of different wavelengths after passing through lenses in the optical system. The astigmatic field curve represents sagittal field curvature and tangential field curvature. The distortion curve represents distortion values corresponding to different angles of view. As can be seen from FIG. 7b (short focal length) and FIG. 7d (long focal length), the longitudinal spherical aberration, the astigmatism, and the distortion of the optical system are well controlled, so that the optical system in this implementation has a good image quality.

Table 8 shows values of fcj/fdj, TTL/FFLdj, fcj/f78, f3/f123, f456/f4, R32/R41, Rg2cj/Rg2dj, SDmax/ImgH, N3/N4>1.2 in the optical systems of the above implementations.

TABLE 8

| | fcj/fdj | TTL/FFLdj | fcj/f78 | f3/f123 | f456/f4 |
|---|---|---|---|---|---|
| First implementation | 2.055 | 12.654 | −1.13 | −1.60 | 1.01 |
| Second implementation | 2.470 | 15.429 | −1.32 | −1.53 | 1.07 |
| Third implementation | 2.016 | 16.392 | −1.12 | −1.59 | 0.98 |
| Fourth implementation | 2.048 | 19.277 | −0.61 | −2.12 | 1.26 |
| Fifth implementation | 2.617 | 15.243 | −1.31 | −1.70 | 1.07 |
| Sixth implementation | 2.434 | 18.619 | −1.20 | −1.61 | 1.00 |
| Seventh implementation | 2.073 | 12.268 | −0.50 | −2.17 | 1.22 |

| | R32/R41 | Rg2cj/Rg2dj | SDmax/ImgH | N3/N4 |
|---|---|---|---|---|
| First implementation | 2.94 | 2.005 | 1.03 | 1.28 |
| Second implementation | 3.16 | 2.211 | 1.11 | 1.28 |
| Third implementation | 3.47 | 2.107 | 1.21 | 1.28 |
| Fourth implementation | 2.29 | 2.109 | 1.11 | 1.28 |
| Fifth implementation | 2.03 | 2.259 | 1.29 | 1.28 |
| Sixth implementation | 4.42 | 2.264 | 1.16 | 1.28 |
| Seventh implementation | 2.19 | 2.118 | 1.09 | 1.28 |

As can be seen in Table 8, the optical systems of the above implementations satisfy the following expressions: 2<fcj/fdj<3, 10<TTL/FFLdj<20, −1.5<fcj/f78<−0.4, −2.5<f3/f123<−1.5, 0.9<f456/f4<1.5, 2<R32/R41<4.5, 2<Rg2cj/Rg2dj<2.5, SDmax/ImgH<1.3, N3/N4>1.2.

What is disclosed above is only some implementations of the disclosure, which cannot be used to limit the scope of the disclosure. A person of ordinary skill in the art can understand all or part of the processes that implement the above-mentioned implementations, and the equivalent changes made according to the claims of the disclosure still fall within the scope of the disclosure.

What is claimed is:

1. An optical system comprising sequentially, from an object side to an image side along an optical axis:
a first lens with a negative refractive power, the first lens having an object-side surface which is convex near the optical axis and an image-side surface which is concave near the optical axis;
a second lens with a negative refractive power;
a third lens with a positive refractive power, the third lens having an object-side surface which is convex near the optical axis and an image-side surface which is concave near the optical axis;
a fourth lens with a positive refractive power, the fourth lens having an object-side surface and an image-side surface which are convex near the optical axis;
a fifth lens with a negative refractive power, the fifth lens having an image-side surface which is concave near the optical axis;
a sixth lens with a refractive power;
a seventh lens with a refractive power, the seventh lens having an object-side surface which is concave near the optical axis and an image-side surface which is convex near the optical axis; and
an eighth lens with a refractive power, the eighth lens having an object-side surface which is convex near the optical axis and an image-side surface which is concave near the optical axis, and the object-side surface and the image-side surface each having at least one inflection point; wherein
the first to third lenses are fixed relative to one another and constitute a first lens group, the first lens group is fixed, the fourth to sixth lenses are fixed relative to one another and constitute a second lens group, the seventh and eighth lenses are fixed relative to each other and constitute a third lens group, and the second lens group and the third lens group are movable along the optical axis; and
the optical system satisfies an expression: 2<fcj/fdj<3,
wherein fcj represents an effective focal length of the optical system at a long focal length end, and fdj represents an effective focal length of the optical system at a short focal length end.

2. The optical system of claim 1, wherein the optical system satisfies an expression:
10<TTL/FFLdj<20,
wherein TTL represents a distance from the object-side surface of the first lens to an imaging surface of the optical system on the optical axis, and FFLdj represents a back focal length of the optical system at the short focal length end.

3. The optical system of claim 1, wherein the optical system satisfies an expression:
−1.5<fcj/f78<−0.4,
wherein fcj represents the effective focal length of the optical system at the long focal length end, and f78 represents a combined effective focal length of the third lens group.

4. The optical system of claim 1, wherein the optical system satisfies an expression:
−2.5<f31f/23<−1.5,
wherein f3 represents an effective focal length of the third lens, and f123 represents a combined effective focal length of the first lens group.

5. The optical system of claim 1, wherein the optical system satisfies an expression:
0.9<f456/f4<1.5,
wherein f456 represents a combined effective focal length of the second lens group, and f4 represents an effective focal length of the fourth lens.

6. The optical system of claim 1, wherein the optical system satisfies an expression:
2<R32/R41<4.5,
wherein R32 represents a radius of curvature of the image-side surface of the third lens at the optical axis, and R41 represents a radius of curvature of the object-side surface of the fourth lens at the optical axis.

7. The optical system of claim 1, wherein the optical system satisfies an expression:
2<Rg2cj/Rg2dj<2.5,
wherein Rg2dj represents a ratio of a total length of the second lens group to a distance from the image-side surface of the third lens to the object-side surface of the seventh lens on the optical axis when the optical system is at the short focal length end, and Rg2cj represents a ratio of the total length of the second lens group to the distance from the image-side surface of the third lens to the object-side surface of the seventh lens on the optical axis when the optical system is at the long focal length end.

8. The optical system of claim 1, wherein the optical system satisfies an expression:
SDmax/ImgH<1.3,
wherein SDmax represents a maximum value of maximum effective semi-diameters of the first to eighth lenses, and ImgH represents half of an image height corresponding to a maximum angle of view of the optical system.

9. A lens module, comprising a lens barrel, a photosensitive element, and an optical system, wherein the optical system are installed inside the lens barrel, and the photosensitive element is disposed at an image side of the optical system, and the optical system comprises sequentially, from an object side to the image side along an optical axis:
a first lens with a negative refractive power, the first lens having an object-side surface which is convex near the optical axis and an image-side surface which is concave near the optical axis;
a second lens with a negative refractive power;
a third lens with a positive refractive power, the third lens having an object-side surface which is convex near the optical axis and an image-side surface which is concave near the optical axis;
a fourth lens with a positive refractive power, the fourth lens having an object-side surface and an image-side surface which are convex near the optical axis;
a fifth lens with a negative refractive power, the fifth lens having an image-side surface which is concave near the optical axis;
a sixth lens with a refractive power;
a seventh lens with a refractive power, the seventh lens having an object-side surface which is concave near the optical axis and an image-side surface which is convex near the optical axis; and
an eighth lens with a refractive power, the eighth lens having an object-side surface which is convex near the optical axis and an image-side surface which is concave near the optical axis, and the object-side surface and the image-side surface each having at least one inflection point; wherein
the first to third lenses are fixed relative to one another and constitute a first lens group, the first lens group is fixed, the fourth to sixth lenses are fixed relative to one another and constitute a second lens group, the seventh and eighth lenses are fixed relative to each other and constitute a third lens group, and the second lens group and the third lens group are movable along the optical axis; and
the optical system satisfies an expression: 2<fcj/fdj<3,
wherein fcj represents an effective focal length of the optical system at a long focal length end, and fdj represents an effective focal length of the optical system at a short focal length end.

10. The lens module of claim 9, wherein the optical system satisfies an expression:
10<TTL/FFLdj<20,
wherein TTL represents a distance from the object-side surface of the first lens to an imaging surface of the optical system on the optical axis, and FFLdj represents a back focal length of the optical system at the short focal length end.

11. The lens module of claim 9, wherein the optical system satisfies an expression:
−1.5<fcj/f78<−0.4,
wherein fcj represents the effective focal length of the optical system at the long focal length end, and f78 represents a combined effective focal length of the third lens group.

12. The lens module of claim 9, wherein the optical system satisfies an expression:
−2.5<f3/f123<−1.5,
wherein f3 represents an effective focal length of the third lens, and f123 represents a combined effective focal length of the first lens group.

13. The lens module of claim 9, wherein the optical system satisfies an expression:
0.9<f456/f4<1.5,
wherein f456 represents a combined effective focal length of the second lens group, and f4 represents an effective focal length of the fourth lens.

14. The lens module of claim 9, wherein the optical system satisfies an expression:
2<R32/R41<4.5,
wherein R32 represents a radius of curvature of the image-side surface of the third lens at the optical axis, and R41 represents a radius of curvature of the object-side surface of the fourth lens at the optical axis.

15. The lens module of claim 9, wherein the optical system satisfies an expression:
2<Rg2cj/Rg2dj<2.5,
wherein Rg2dj represents a ratio of a total length of the second lens group to a distance from the image-side surface of the third lens to the object-side surface of the seventh lens on the optical axis when the optical system is at the short focal length end, and Rg2cj represents a ratio of the total length of the second lens group to the distance from the image-side surface of the third lens to the object-side surface of the seventh lens on the optical axis when the optical system is at the long focal length end.

16. The lens module of claim 9, wherein the optical system satisfies an expression:
SDmax/ImgH<1.3,
wherein SDmax represents a maximum value of maximum effective semi-diameters of the first to eighth lenses, and ImgH represents half of an image height corresponding to a maximum angle of view of the optical system.

17. An electronic device, comprising a housing and a lens module, wherein the lens module is received in the housing, and the lens module comprises a lens barrel, a photosensitive element, and an optical system, wherein the optical system are installed inside the lens barrel, and the photosensitive element is disposed at an image side of the optical system, and the optical system comprises sequentially, from an object side to the image side along an optical axis:
a first lens with a negative refractive power, the first lens having an object-side surface which is convex near the optical axis and an image-side surface which is concave near the optical axis;
a second lens with a negative refractive power;
a third lens with a positive refractive power, the third lens having an object-side surface which is convex near the optical axis and an image-side surface which is concave near the optical axis;
a fourth lens with a positive refractive power, the fourth lens having an object-side surface and an image-side surface which are convex near the optical axis;
a fifth lens with a negative refractive power, the fifth lens having an image-side surface which is concave near the optical axis;
a sixth lens with a refractive power;
a seventh lens with a refractive power, the seventh lens having an object-side surface which is concave near the optical axis and an image-side surface which is convex near the optical axis; and
an eighth lens with a refractive power, the eighth lens having an object-side surface which is convex near the optical axis and an image-side surface which is concave near the optical axis, and the object-side surface and the image-side surface each having at least one inflection point; wherein
the first to third lenses are fixed relative to one another and constitute a first lens group, the first lens group is fixed, the fourth to sixth lenses are fixed relative to one another and constitute a second lens group, the seventh and eighth lenses are fixed relative to each other and constitute a third lens group, and the second lens group and the third lens group are movable along the optical axis; and
the optical system satisfies an expression: 2<fcj/fdj<3,
wherein fcj represents an effective focal length of the optical system at a long focal length end, and fdj represents an effective focal length of the optical system at a short focal length end.

18. The electronic device of claim 17, wherein the optical system satisfies an expression:
10<TTL/FFLdj<20,
wherein TTL represents a distance from the object-side surface of the first lens to an imaging surface of the optical system on the optical axis, and FFLdj represents a back focal length of the optical system at the short focal length end.

19. The electronic device of claim 17, wherein the optical system satisfies an expression:
−1.5<fcj/f78<−0.4,
wherein fcj represents the effective focal length of the optical system at the long focal length end, and f78 represents a combined effective focal length of the third lens group.

20. The electronic device of claim 17, wherein the optical system satisfies an expression:
−2.5<f3/f123<−1.5,
wherein f3 represents an effective focal length of the third lens, and f123 represents a combined effective focal length of the first lens group.
